(19) United States
(12) Patent Application Publication
(10) Pub. No.: US 2013/0224377 A1
(43) Pub. Date: Aug. 29, 2013

(54) SURFACE FUNCTIONALIZATION OF CARBON NANOTUBES VIA OXIDATION FOR SUBSEQUENT COATING

(71) Applicant: Brigham Young University, (US)

(72) Inventor: David Scott Jensen, Provo, UT (US)

(73) Assignee: Brigham Young University, Provo, UT (US)

(21) Appl. No.: 13/773,969

(22) Filed: Feb. 22, 2013

Related U.S. Application Data
(60) Provisional application No. 61/634,358, filed on Feb. 28, 2012.

(51) Int. Cl. B05D 5/00

(52) U.S. Cl. CPC B05D 5/00
USPC 427/237

(57) ABSTRACT

In an embodiment, a method for manufacturing a chromatography apparatus such as a thin layer chromatography (“TLC”) plate is disclosed. The method includes forming a layer of elongated nanostructures (e.g., carbon nanotubes), oxidizing the elongated nanostructures to form a surface enriched in oxygen moieties, and at least partially coating the oxidized elongated nanostructures with a coating. The coating includes a stationary phase and/or precursor of a stationary phase for use in chromatography. The stationary phase may be functionalized with hydroxyl groups by exposure to a base or acid. The stationary phase may further be treated with a silane (e.g., an amino silane) to improve the performance of the chromatography apparatus. Embodiments for TLC plates and related methods are also disclosed.

### CROSS-REFERENCE TO RELATED APPLICATIONS

This application claims the benefit of U.S. Provisional Application No. 61/634,358 filed on 28 Feb. 2012, the disclosure of which is incorporated herein, in its entirety, by this reference.

### BACKGROUND

Chromatography and solid-phase extraction (“SPE”) are commonly-used separation techniques employed in a variety of analytical chemistry and biochemistry environments. Chromatography and SPE are often used for separation, extraction, and analysis of various constituents, or fractions, of a sample of interest. Chromatography and SPE may also be used for the preparation, purification, concentration, and clean-up of samples.

Chromatography and SPE relate to any of a variety of techniques used to separate complex mixtures based on differential affinities of components of a sample carried by a mobile phase with which the sample flows, and a stationary phase through which the sample passes. Typically, chromatography and SPE involve the use of a stationary phase that includes an adsorbent packed into a cartridge, column, or disposed as a thin layer on a plate. Thin-layer chromatography (“TLC”) employs a stationary phase that is spread in a thin layer on a carrier or substrate plate. A commonly-used stationary phase includes a silica-gel-based sorbent material.

Mobile phases are often solvent-based liquids, although gas chromatography typically employs a gaseous mobile phase. Liquid mobile phases may vary significantly in their compositions depending on various characteristics of the sample being analyzed and on the various components sought to be extracted and/or analyzed in the sample. For example, liquid mobile phases may vary significantly in pH and solvent properties. Additionally, liquid mobile phases may vary in their compositions depending on the characteristics of the stationary phase that is being employed. Often, several different mobile phases are employed during a given chromatography or SPE procedure. For example, gradient elution may be performed in which the mobile phase composition is varied with time.

A typical TLC plate is prepared by mixing an adsorbent (which acts as the stationary phase) with a small amount of an inert binder and water. The mixture may be spread as a relatively viscous slurry onto a carrier sheet. The resulting plate can then be dried and activated in an oven. The resulting stationary phase is bound in place to the carrier sheet or other substrate by the binder. The presence of the binder can lead to secondary interactions with the mobile phase, as well as a decrease in separation efficiency.

### SUMMARY

Embodiments of the invention are directed to chromatography apparatus such as TLC plates, methods of using such TLC plates in chromatography, and related methods of manufacture in which a plurality of elongated stationary phase structures are formed and affixed to a substrate without the use of a separate binder. The elimination of the use of any binder may prevent unwanted secondary interactions, as well as improve separation efficiency.

In an embodiment, a method for manufacturing chromatography apparatus (e.g., a TLC plate) is disclosed. The method includes forming a catalyst layer on a substrate. A layer of elongated nanostructures (e.g., carbon nanotubes) is then formed on the catalyst layer. The elongated nanostructures so formed are oxidized (e.g., ozone treated by contacting the elongated nanostructures with ozone) to form a surface enriched in oxygen moieties for promoting subsequent deposition of a coating including at least one of a stationary phase or a precursor of a stationary phase for use in chromatography. The stationary phase coating or precursor thereof is then deposited on the surface enriched in oxygen moieties. The coating adheres to the oxygen enriched surface to a greater degree than the coating would adhere to the elongated nanostructures without the oxygen enriched surface resulting from ozone treatment. In some embodiments, after depositing the coating, the elongated nanostructures may be at least partially removed. Although priming is not necessary, in some embodiments, priming may still be performed.

For example, in an embodiment, a method comprises forming a catalyst layer on a substrate; forming a layer of elongated nanostructures on the catalyst layer; optionally priming the elongated nanostructures to optionally form a layer of primed elongated nanostructures by at least partially coating the elongated nanostructures with at least one adhesion priming layer for promoting subsequent deposition of a coating including at least one of a stationary phase or a precursor of a stationary phase for use in chromatography; oxidizing the priming layer, the elongated nanostructures, or both to form a surface enriched in oxygen moieties for promoting subsequent deposition of a coating including at least one of a stationary phase or a precursor of a stationary phase for use in chromatography; and at least partially coating the surface enriched in oxygen moieties with the coating including at least one of a stationary phase or a precursor of a stationary phase.

In an embodiment, a TLC plate is disclosed. The TLC plate may be as results from the method described above. In an embodiment, the plurality of stationary phase structures may be arranged on the substrate in a selected pattern. The stationary phase structure (e.g., a silica material) may further include a plurality of silanol groups bonded thereto which provide a functionalized surface for enhanced separation performance. Silane groups (e.g., an amino silane or an octadecyl silane) may also be bonded to the stationary phase structure surface for improved performance.

In an embodiment, a method of performing chromatography is disclosed. The method includes providing a TLC plate as described above. The method further includes applying a sample to be analyzed to the plurality of stationary phase structures of the TLC plate, and drawing a mobile phase through the plurality of stationary phase structures having the sample applied thereto. The different components of the sample may be separated as the mobile phase and the sample interact with the TLC plate.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

FIG. 1 is a schematic top plan view of an embodiment of a TLC plate intermediate structure including a substrate and a catalyst layer disposed over the substrate, with the catalyst layer exhibiting a zigzag pattern.

FIG. 2 is a schematic top plan view of another embodiment of a TLC plate intermediate structure similar to FIG. 1, but the catalyst layer exhibits an alternative zigzag pattern.

FIG. 3 is a schematic top plan view of another embodiment of a TLC plate intermediate structure similar to FIG. 1, but the catalyst layer exhibits a substantially parallel spacing pattern.

FIG. 4 is a schematic top plan view of another embodiment of a TLC plate intermediate structure similar to FIG. 3, but the catalyst layer exhibits another substantially parallel spacing pattern.

FIG. 5 is a schematic top plan view of another embodiment of a TLC plate intermediate structure similar to FIG. 1, but the catalyst layer exhibits a diamond-shaped pattern.

FIG. 6 is a schematic top plan view of another embodiment of a TLC plate intermediate structure similar to FIG. 5, but the catalyst layer exhibits another diamond-shaped pattern.

FIG. 7 is a schematic top plan view of another embodiment of a TLC plate intermediate structure similar to FIG. 1, but the catalyst layer exhibits a honeycomb-like pattern.

FIG. 8 is a schematic top plan view of another embodiment of a TLC plate intermediate structure similar to FIG. 7, but the catalyst layer exhibits another honeycomb-like pattern.

FIG. 9 is a schematic top plan view of another embodiment of a TLC plate intermediate structure similar to FIG. 7, but the catalyst layer exhibits another honeycomb-like pattern.

FIG. 10A is a cross-sectional view of the TLC plate intermediate structure of FIG. 1.

FIG. 10B is a cross-sectional view of the TLC plate intermediate structure of FIG. 10A with CNTs grown on the catalyst layer once the CNTs have been subjected to ozone treatment to provide an oxygen enriched surface.

FIG. 10C is a close-up transverse cross-sectional view of an another embodiment in which the CNT includes one or more priming layer(s), where the CNTs, priming layer(s) or both have been subjected to ozone treatment.

FIG. 10D is a cross-sectional view of the TLC plate intermediate structure of FIG. 10B once the ozone treated CNTs have been at least partially coated by a stationary phase coating.

FIG. 10DD is a close-up transverse cross-sectional view of one of the coated CNTs of FIG. 10D.

FIG. 10E is a cross-sectional view of the TLC plate intermediate structure of FIG. 10D once the CNTs have been burned off, leaving behind the stationary phase structures.

FIG. 10EE is a close-up transverse cross-sectional view similar to FIG. 10DD, but once the CNTs have been burned off.

FIG. 11A is a schematic top plan view of a TLC plate manufactured from a TLC plate intermediate structure similar to that of FIG. 1.

FIG. 11B is a close-up top plan view of the TLC plate intermediate structure of FIG. 11A showing several of the high aspect ratio deposited stationary phase structures disposed on the TLC plate substrate.

FIG. 12 is a scanning electron microscopy (“SEM”) image of an embodiment of a non-linear zig-zag stationary phase that may be formed according to methods disclosed herein.

FIGS. 13A-13D are SEM images of a TLC stationary phase formed by directly applying a silica stationary phase over CNTs that were ozone treated with ozone generated from a UV lamp (exposure time=15 minutes) through pseudo atomic layer deposition (“ALD”), without any priming layer between the CNTs and the silica stationary phase.

FIGS. 14A-14D are SEM images of a TLC stationary phase formed by directly applying a silica stationary phase over CNTs that were ozone treated with ozone generated from a UV lamp (exposure time=45 minutes) through pseudo-ALD, without any priming layer between the CNTs and the silica stationary phase.

FIGS. 15A-15D are SEM images of a TLC stationary phase formed by directly applying a silica stationary phase over CNTs that were ozone treated with ozone generated from an ozone generator (exposure time=15 minutes) through pseudo-ALD, without any priming layer between the CNTs and the silica stationary phase.

FIGS. 16A-16D are SEM images of a TLC stationary phase formed by directly applying a silica stationary phase over CNTs that were ozone treated with ozone generated from an ozone generator (exposure time=45 minutes) through pseudo-ALD, without any priming layer between the CNTs and the silica stationary phase.

FIG. 17A is an SEM image of a TLC plate prepared without priming or ozone treatment of the CNTs, and in which a silicon precursor of a silica stationary phase is oxidized to silica substantially simultaneously with oxidative removal of the CNTs.

FIG. 17B is an SEM image of a TLC plate prepared with priming of the CNTs, and in which a silica stationary phase is directly deposited, requiring no oxidation of a stationary phase precursor, followed by oxidative removal of the CNTs at a relatively low temperature. Ozone treatment rather than priming provides similar looking results.

FIG. 18 is a schematic view illustrating various flow channel width, channel length, and hedge width configurations for a zig-zag pattern according to an embodiment.

FIG. 19 plots increase in atomic oxygen concentration at the surface of CNTs as a result of exposure to ozone over time.

FIG. 20 is a representative SEM image of a CNT forest after adequate ozone treatment and pseudo-ALD deposition of SiO₂ as described in the working examples.

FIGS. 21A and 21B show the separation results of two fluorescent dyes two plates with different geometries.

FIG. 22 is a plot showing development times for the various working example plates versus channel width of the different plates.

### DETAILED DESCRIPTION

### I. Introduction

Embodiments of the invention are directed to TLC plates and related methods of manufacture and use. The disclosed TLC plates may include a plurality of elongated stationary phase structures affixed to a substrate without the use of a separate binder to provide a highly porous structure suitable for chromatography applications. The elimination of the use of any binder may prevent unwanted secondary interactions, as well as may improve separation efficiency.

A layer of elongated nanostructures are formed on a catalyst layer on a substrate. The elongated nanostructures (which may optionally be primed, although priming is not necessary) may be treated with ozone or treated by another suitable oxidation process, resulting in a surface that is enriched in oxygen moieties, which serves to prime the surface for better adhesion of the subsequently applied stationary phase or precursor thereof. It has been found that a priming layer is not required where the elongated nanostructures are oxidized, allowing direct deposition of the stationary phase or precursor thereof, and the resulting TLC plate structure has stability characteristics comparable to TLC plate structures which were primed rather than oxidized. In addition, the ozone treated embodiments exhibit separation performance that may be significantly improved over the primed embodiments. Replacement of the priming step(s) with ozone treatment or other oxidation process provides comparable or improved results through a process that is significantly simpler.

### II. Methods for Manufacturing TLC Plates and Resulting TLC Plates

In various embodiments, a TLC plate may be manufactured by forming a layer of elongated nanostructures on a substrate, oxidizing (e.g., ozone treating) the elongated nanostructures, and then at least partially coating the elongated nanostructures with a coating that comprises a stationary phase and/or a precursor to the stationary phase for use in chromatography. While the description hereinbelow uses CNTs as an example of a suitable elongated nanostructure, other elongated nanostructures may be used, such as semiconductor nanowires with or without a porous coating, metallic nanowires with or without a porous coating, nanopillars formed by nanoimprint lithography, combinations of the foregoing, or any other suitable nano structure.

While priming of the CNTs with a thin priming layer (e.g., such as amorphous carbon, alumina, etc.) may not be necessary, in some embodiments, the CNTs may optionally be primed before deposition of the stationary phase or precursor thereof, if desired. In such cases, the elongated nanostructures, the one or more adhesion priming layers, or both may be ozone treated or otherwise oxidized to provide a surface enriched in oxygen moieties.

The CNTs may generally be vertically aligned relative to one another, although some contact and/or at least partial intertwining of adjacent CNTs may occur, which may provide increased mechanical stability to individual “hedge” portions of a given pattern, or to the overall CNT forest. Such intertwining is readily seen in the included SEM images. The CNTs (which may optionally be primed) are ozone treated or otherwise oxidized to form a surface enriched in oxygen moieties for promoting subsequent deposition of the stationary phase coating or precursor thereof. The surface may then be coated with a stationary phase that has a thickness less than the CNT hedge spacing (i.e., leaving a “flow channel”), which results in a porous medium through which separation by means of chromatography may occur. The resulting pattern may thus include a series of hedges separated by flow channels. The CNT forest is used as a framework on which the stationary phase may be coated and/or formed, resulting in a finished structure that is generally free of any binder for binding the stationary phase to the substrate.

The substrate may include a base, a backing layer disposed on the base, and a catalyst layer disposed on the backing layer that is used to catalyze growth of CNTs over the substrate. Generally, the catalyst layer may be deposited onto the backing layer by any suitable technique. For example, placement of the catalyst layer may be accomplished using a photolithography process, such as masking the catalyst layer and etching to remove regions of the catalyst layer exposed through the mask. Such photolithography processes may be used to produce a catalyst layer having a selected non-linear (e.g., zigzag) pattern. Other patterning processes such as shadow masking with a stencil during catalyst deposition or printing may also be used. In another embodiment, the catalyst layer may be applied so as to coat substantially the entire substrate.

The catalyst layer may comprise any suitable material that catalyzes growth of CNTs under suitable growing conditions (e.g., heating and exposure to a process gas such as H₂ and a carbon containing gas such as C₂H₄). Various transition metals may be suitable for use as a catalyst layer. Suitable metals include, but are not limited to iron, nickel, copper, cobalt, alloys of the forgoing metals, and combinations thereof.

The backing layer of the substrate provides support for the structures of the TLC plate. For example, the backing layer provides a support on which the catalyst layer may be deposited, and may also function as a diffusion barrier to help prevent a chemical reaction between the catalyst layer and the base. Examples of backing layer materials may include, but are not limited to, silica (e.g., fused silica), alumina, a low-expansion high-temperature borosilicate glass (e.g., Pyrex 7740 and/or Schott Borofloat glass), steel (e.g., stainless steel), a silicon wafer, a nickel substrate, or any other high-temperature glass or other suitable material. In embodiments where the backing layer comprises a material other than alumina, the backing layer may be prepared for CNT growth by application of a thin layer of alumina over the non-alumina backing layer. The alumina layer may have a thickness between about 5 nm and about 100 nm, more specifically between about 10 nm and about 50 nm, and most specifically between about 20 nm and about 40 nm (e.g., about 30 nm).

A catalyst layer (e.g., iron) may be applied over the backing layer. The catalyst layer may have a thickness between about 0.1 nm and about 15 nm, more particularly between about 0.5 nm and about 10 nm, and even more particularly between about 0.5 nm and about 8 nm (e.g., about 2 to about 7 nm). For example, the catalyst layer may have a thickness of about 0.5 nm, about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, or about 15 nm. Although specific catalyst layer thicknesses are disclosed above, the inventor has further found that varying the thickness of the catalyst layer affects some or each of the diameter, density, or height of CNTs grown under otherwise identical conditions. As such, according to an embodiment, the catalyst layer thickness may be altered to change one or more of diameter, density, or height of the grown CNTs.

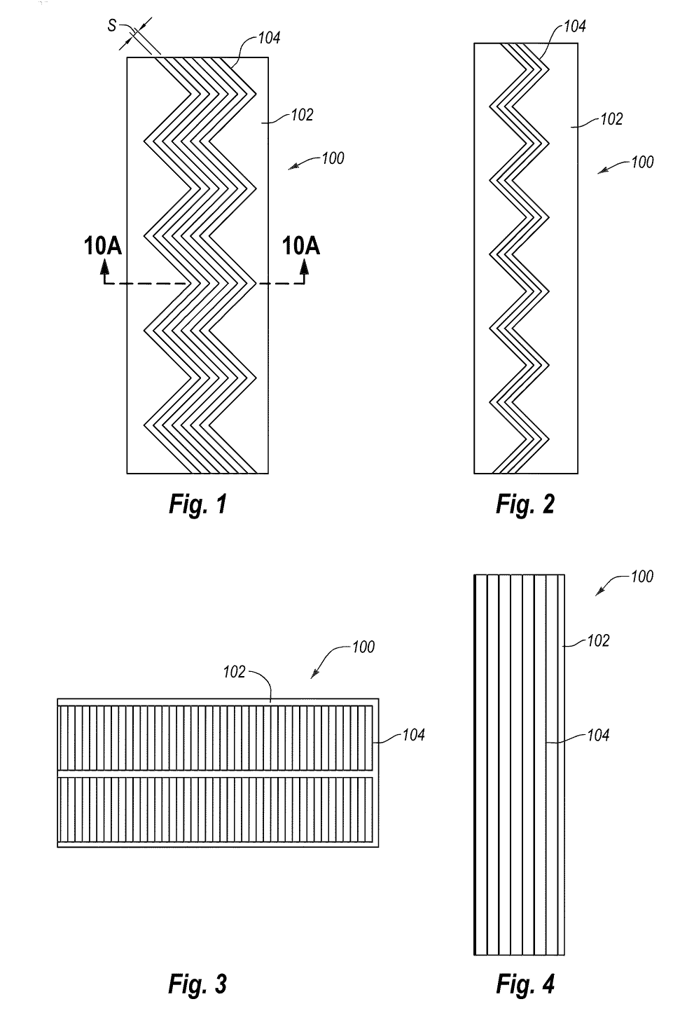

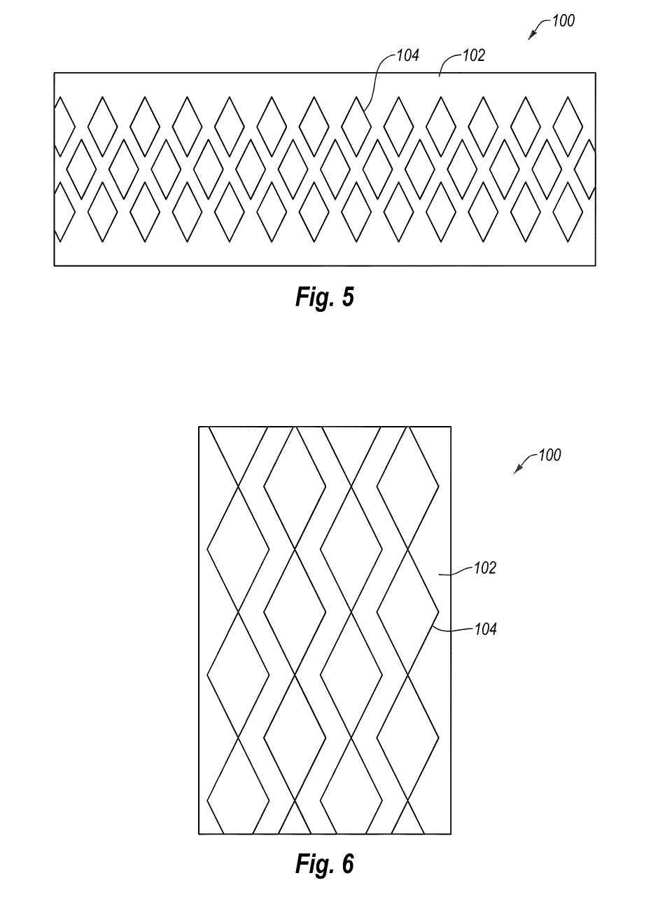

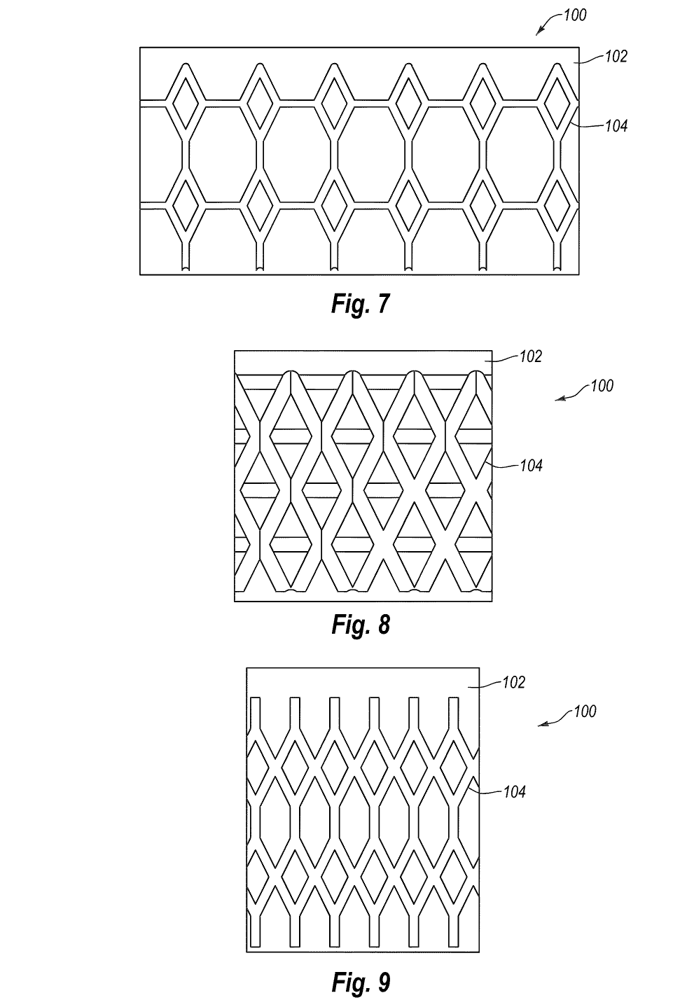

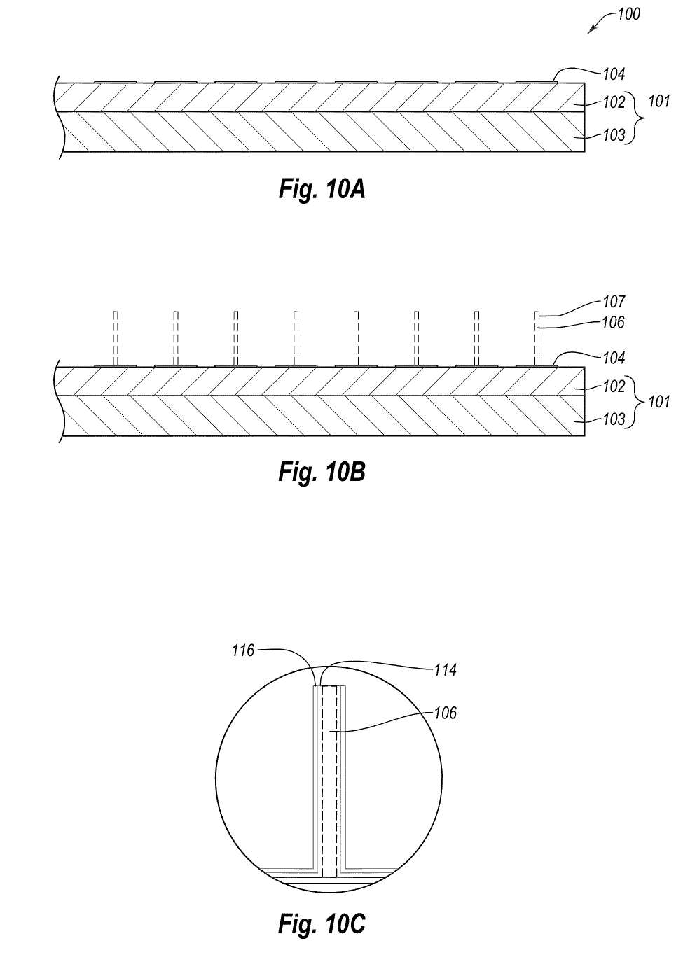

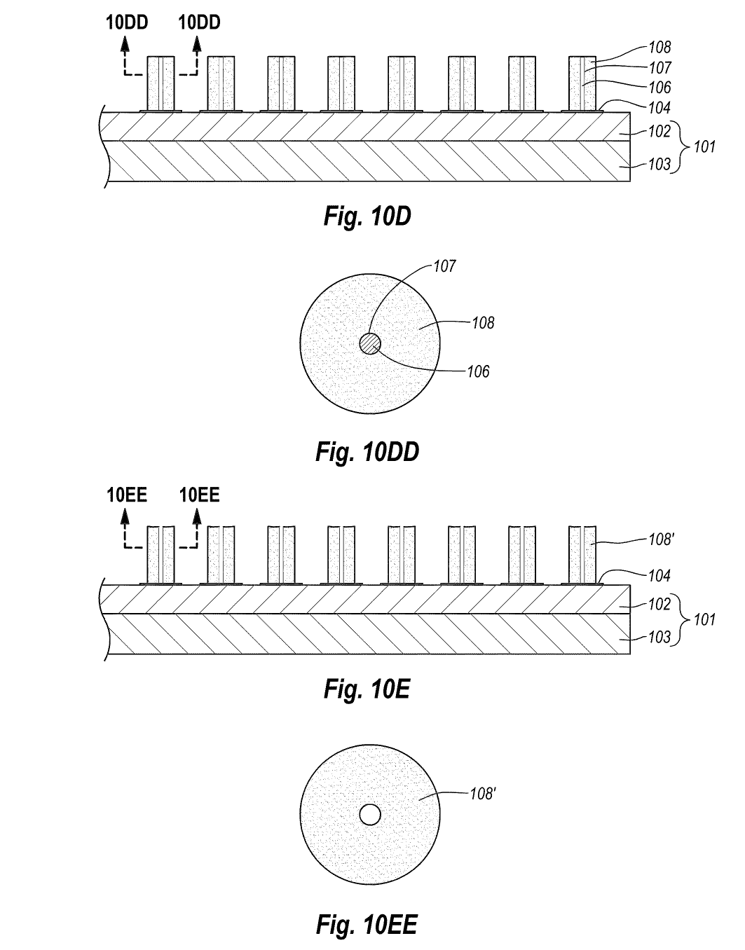

The catalyst layer may be applied in a selected linear pattern, a selected non-linear pattern, or other selected pattern, or may be applied over substantially an entire surface of the backing layer. Various embodiments of patterns for the catalyst layer are shown in FIGS. 1-9. For example, FIGS. 1 and 10A show a TLC plate intermediate structure 100 including a substrate 101 having a backing layer 102 disposed on a base 103 and a catalyst layer 104 formed on backing layer 102 in a non-linear zigzag pattern, with the patterned catalyst represented by the dark lines. In some embodiments, periodic breaks may be formed in some or all of the zigzag portions of catalyst layer 104 to provide a more uniform average mobile phase velocity to the TLC plate to be ultimately formed. FIG. 2 illustrates another embodiment of a zigzag pattern for catalyst layer 104, with the patterned catalyst represented by the dark lines (e.g., a series of “hedges” separated from one another by adjacent flow channels). FIGS. 3 and 4 each show a TLC plate intermediate structure 100 including substrate 101 having backing layer 102 disposed on base 103 and catalyst layer 104 formed on backing layer 102 in substantially parallel patterns according to another embodiment, with the patterned catalyst represented by the dark lines. FIGS. 5 and 6 each shows a TLC plate intermediate structure 100 including substrate 101 having backing layer 102 disposed on base 103 and catalyst layer 104 formed on backing layer 102 in various repeating diamond patterns according to various embodiments, with the diamonds representing the catalyst. FIGS. 7-9 each shows a TLC plate intermediate structure 100 including a substrate 101 having backing layer 102 disposed on base 103 and catalyst layer 104 formed on backing layer 102 in different honeycomb-like patterns according to various embodiments. FIGS. 1 and 2 and 5-9 each show a non-linear catalyst pattern, while the patterns of FIGS. 3 and 4 show generally linear catalyst patterns.

The catalyst layer 104 may be patterned to exhibit any desired spacing between adjacent portions of the patterned catalyst layer 104. For example, an average bed spacing “S” is shown in FIG. 1. In an embodiment, an average bed spacing between adjacent portions of patterned catalyst layer 104 is between about 0.2 μm and about 50 μm, more particularly between about 0.5 μm and about 20 μm, and most particularly between about 1 μm and about 10 μm (e.g., about 10 μm). One of ordinary skill in the art will appreciate that catalyst layer 104 may be formed so as to have any desired pattern and/or spacing “S.” In another embodiment, the catalyst layer 104 may be formed so as to cover substantially the entire backing layer 102, lacking any particular distinct pattern. In some embodiments, catalyst layer 104 is spaced inwardly from edges of backing layer 102 in order to substantially prevent growth of CNTs on the edges. In some embodiments, the spacing “S” may vary in one or two directions, such as from zigzag portion to zigzag portion.

With catalyst layer 104 formed on backing layer 102, TLC plate intermediate structure 100 may be placed onto a suitable support (e.g., a quartz support) within a furnace and heated to a temperature within a range of about 600° C. to about 900° C., more particularly between about 650° C. to about 850° C., and even more particularly to between about 700° C. to about 800° C. (e.g., about 750° C.). Prior to CNT growth, the catalyst layer 104 may be annealed in an annealing process in which H₂ or another process gas is flowed over the catalyst layer 104 (e.g., within a fused silica tube) while the temperature is increased from ambient temperature to the temperature at which CNT growth will occur. Flow of H₂ may be about 300 cm³/min or other suitable flow rate.

A process gas (e.g., H₂, ammonia, N₂, or combinations thereof) and a carbon-containing gas (e.g., acetylene, ethylene, ethanol, methane, or combinations thereof) are introduced and flowed over the catalyst layer 104. A noble gas (e.g., argon) may also be included with the carbon-containing gas stream to control the rate of growth of CNTs on and over the catalyst layer 104. Flow of the process gas and carbon-containing gas (e.g., ethylene) may be within a ratio of about 0.5:1 to about 1, more particularly between about 0.55:1 and about 0.85:1, and even more particularly between about 0.6:1 and about 0.8:1.

Once the desired height of CNT growth is achieved, flow of the process gas and carbon-containing gas are turned off, and the furnace chamber may be purged with flow of a noble gas (e.g., argon) as the furnace is partially cooled, for example to a temperature between about 100° C. to about 300° C., more particularly between about 150° C. to about 250° C., and even more particularly to between about 175° C. to about 225° C. (e.g., about 200° C.).

In one embodiment, and in order to achieve a higher aspect ratio of base width to CNT height, a “start/stop” method may be employed. For example, the carbon-containing gas may be turned off during CNT growth, causing the CNTs to grow in a myriad of directions. This type of growth may be desired in some embodiments, as it may lead to more mechanically stable CNTs (e.g., such adjacent CNTs may be more likely to contact and/or at least partially intertwine with one another).

FIG. 10B is a cross-sectional view of an embodiment of a structure similar to that of FIGS. 1 and 10A in which CNTs 106 have been grown on and over catalyst layer 104. CNTs 106 may be grown to extend longitudinally away from the substrate 101. For example, the CNTs may extend substantially perpendicular (i.e., vertical) to respective surfaces of catalyst layer 104 and substrate 101. Grown CNTs 106 may be single walled or multi-walled, as desired. Grown CNTs 106 may have an average diameter between about 3 nm and about 20 nm, more particularly between about 5 nm and about 10 nm (e.g., about 8.5 nm) and an average length of about 1 μm to about 2000 μm, about 5 μm to about 1000 μm, about 10 μm to about 500 μm, about 20 μm to about 400 μm, about 20 μm to about 200 μm, about 100 μm to about 300 μm, about 10 μm to about 100 μm, or about 20 μm to about 200 μm. The grown CNTs 106 may exhibit an average aspect ratio (i.e., ratio of average length to average diameter) of about 10,000 to about 2,000,000, such about 10,000 to about 1,000,000, or about 100,000 to about 750,000.

The average length to which CNTs 106 are grown may be chosen based on the particular chromatography application. For example, the average length of the CNTs 106 may be about 2 μm to about 100 μm for ultra-thin layer chromatography (“UTLC”), the average length of the CNTs 106 may be about 100 μm to about 300 μm for high-performance thin layer chromatography (“HPTLC”), and the average length of the CNTs 106 may be about 500 μm to about 2000 μm for preparative liquid chromatography (“PLC”).

Additional details regarding growth of CNTs 106 may be found in U.S. patent application Ser. Nos. 12/239,281 and 12/239,339 entitled X-RAY RADIATION WINDOW WITH CARBON NANOTUBE FRAME. Both of the above applications claim priority to U.S. Provisional Patent Application No. 60/995,881. U.S. patent application Ser. No. 12/239,281 and 12/239,339 and U.S. Provisional Patent Application No. 60/995,881 are each incorporated herein, in their entirety, by this reference. Further details may be found in U.S. patent application Ser. No. 13/035,645 filed Feb. 25, 2011, which is also incorporated herein by reference in its entirety.

Although CNTs 106 are illustrated as being uniformly spaced, CNTs 106 may be at least partially intertwined with each other to form a vertical wall of CNTs 106. Furthermore, adjacent “hedges” of CNTs 106 may comprise a plurality of grouped CNTs, which may be at least partially intertwined with each other (e.g., more than one CNT may be grown side by side with the illustrated CNT on the shown catalyst layer 104). Only one CNT is shown on each catalyst layer 104 for simplicity. Such hedges of CNTs may be separated by a flow channel between another adjacent hedge. As previously discussed, the at least partial intertwining and/or contact of CNTs 106 with each other helps reduce, limit, or prevent the vertical wall of CNTs 106 from bending out of plane. Furthermore, the rigidity of the wall of CNTs 106 may be further enhanced to reduce, limit, or prevent out of plane bending thereof by patterning catalyst layer 104 in a selected non-linear pattern (e.g., the pattern shown in FIG. 1) and growing respective portions of CNTs 106 on the individual non-linear portions of catalyst layer 104 to form respective walls of CNTs 106.

The CNTs are used as a framework to be infiltrated with a material that may increase the mechanical stability of the overall structure and provide a stationary phase for use in chromatography applications. Optionally, one or more priming layers may be applied to the CNTs in preparation for infiltration, which priming may further increase the mechanical stability of the overall structure. For example, application of the priming layer(s) may contribute to prevention or minimization any tendency of the resulting stationary phase to delaminate, buckle, or otherwise separate from the substrate 101.

Application of any priming layer(s) is optional, as it has been found that results exhibiting good mechanical stability and good stationary phase adhesion can be obtained with less complexity by ozone treating the formed CNTs. Where a priming layer is present, the priming layer(s) may themselves be ozone treated or otherwise oxidized. Ozone treatment or other oxidation process results in formation of surfaces that are enriched in oxygen moieties, which are helpful in promoting subsequent deposition of the stationary phase coating or precursor thereof.

FIG. 10C shows optional priming layers 114, 116 applied to CNTs 106. Each priming layer 114, 116 may be relatively thin. For example, the thickness of any given priming layer may be from about 1 nm to about 20 nm, from about 2 nm to about 15 nm, or from about 2 nm to about 12 nm. The priming layer may thus be significantly thinner than a subsequently applied stationary phase or precursor thereof (which may typically be about 100 nm in thickness).

Materials used for priming may be the same or similar materials as those used for infiltration with the stationary phase or its precursor. Examples of such priming materials include, but are not limited to, elemental silicon, silicon dioxide, silicon nitride, elemental aluminum, aluminum oxide, elemental zirconium, zirconium oxide (e.g., zirconium dioxide), elemental titanium, titanium oxide, amorphous carbon, graphitic carbon, and combinations of the foregoing. In an embodiment, the priming layers are selected from amorphous carbon, aluminum oxide, and combinations thereof. For example, in an embodiment, priming layer 114 adjacent to CNTs 106 may include amorphous carbon, while priming layer 116 adjacent to priming layer 114 may comprise alumina (i.e., aluminum oxide).

Application of the one or more priming layers may be achieved at appropriate temperatures. For example, deposition of amorphous carbon can be carried out at a temperature at a somewhat higher range than that described above relative to CNT growth. For example, deposition of amorphous carbon can be carried out from about 800° C. to about 1000° C., from about 850° C. to about 950° C., or about 900° C. while flowing ethylene and argon over the CNTs. In an embodiment, the amorphous carbon priming layer is formed to be not more than about 10 nm thick, from about 2 nm to about 8 nm thick, or from about 3 nm to about 5 nm thick.

Deposition of alumina as a priming layer by ALD may be carried out at significantly lower temperatures, e.g., from about 150° C. to about 350° C., from about 200° C. to about 300° C., or about 250° C. while cycling trimethylaluminum and water in a serial, repeating (e.g., in an ABAB fashion) for a desired number of cycles. Deposition of about 0.1 nm per cycle is typical. In an embodiment, the alumina layer is formed to be from about 5 nm to about 15 nm thick, or from about 6 nm to about 12 nm thick. Additional details of priming layer(s) and their deposition may be found in U.S. patent application Ser. No. 13/368,869 entitled THIN LAYER CHROMATOGRAPHY PLATES AND RELATED METHODS OF MANUFACTURE INCLUDING PRIMING PRIOR TO INFILTRATION WITH STATIONARY PHASE AND/OR PRECURSOR THEREOF, which is incorporated herein, in its entirety, by this reference.

Whether primed or not, CNTs 106 may be subjected to ozone treatment or other oxidation process to form a surface enriched in oxygen moieties. Ozone treatment is significantly simpler than priming as described above, and has been found by the inventor to provide comparable, if not superior, results. Ozonation appears to increase the number of nucleation sites on the CNTs by oxidizing them (but not burning them away), thereby facilitating conformal growth of silica or another stationary phase or precursor thereof.

Ozone treatment may be straightforward, involving passing gaseous ozone over the patterned CNT forest. Ozone may be provided by any suitable technique (e.g., UV lamp generation, other commercial ozone generator, etc.). For example, exposure of diatomic oxygen or air (containing diatomic oxygen) to UV radiation (e.g., 185 nm wavelength) splits the diatomic oxygen molecules, which attach to other diatomic oxygen molecules, forming ozone (O₃). An ozone stream may be passed over the patterned CNT forest for a sufficient period of time, (e.g., depending on ozone concentration in the stream, temperature, etc.) to increase the number of oxygen rich nucleation sites on the CNTs. For example, time periods from about 3 minutes to about 2 hours, from about 4 minutes to about 1 hours, or from about 5 minutes to about 1 hour are typically sufficient (e.g., at least about 15 minutes, about 15 minutes to about 1 hour, or about 20 minutes to about 45 minutes). The ozone treatment may be conducted at ambient pressure and temperature (e.g., about 1 atmosphere and about 20° C. to about 25° C.) or at elevated temperature to speed up the oxidation process time.

In an embodiment, ozone treatment or other oxidation process may raise the oxygen content at the surface (e.g., as measured by XPS) to at least about 0.5 atomic percent, at least about 1 atomic percent, or at least about 2 atomic percent. The inventor has found that oxygen surface content values of at least about 2 atomic percent (e.g., about 2 atomic percent to about 6 atomic percent, about 2 atomic percent to about 5 atomic percent, or about 2 atomic percent to about 4 atomic percent) result in relatively good coating of the subsequent stationary phase or precursor thereof.

In an embodiment, the ozone stream may comprise a mixture of ozone and other components (e.g., air, oxygen, a noble gas, etc.). For example, the ozone stream may comprise about 40% to about 60% ozone and about 40% to about 60% oxygen, or approximately equal fractions of ozone and oxygen. In another embodiment, the ozone stream may comprise hydrogen peroxide (e.g., a mixture of hydrogen peroxide and ozone). Such ozone treatment may be employed to prepare CNTs for other types of depositions.

In other embodiments, other oxidation processes beside ozone treatment may be employed. For example, other gaseous oxidation processes may be used, such as contacting the CNTs and/or the priming layer(s) with gaseous hydrogen peroxide (H₂O₂), peroxide, other peroxide containing compound, CO₂, CO, O₂, oxides of nitrogen, or combinations thereof in conjunction with exposure to UV light. The inventors currently believe that in some circumstances exposing the CNTs to fluids may damage and/or destroy CNTs.

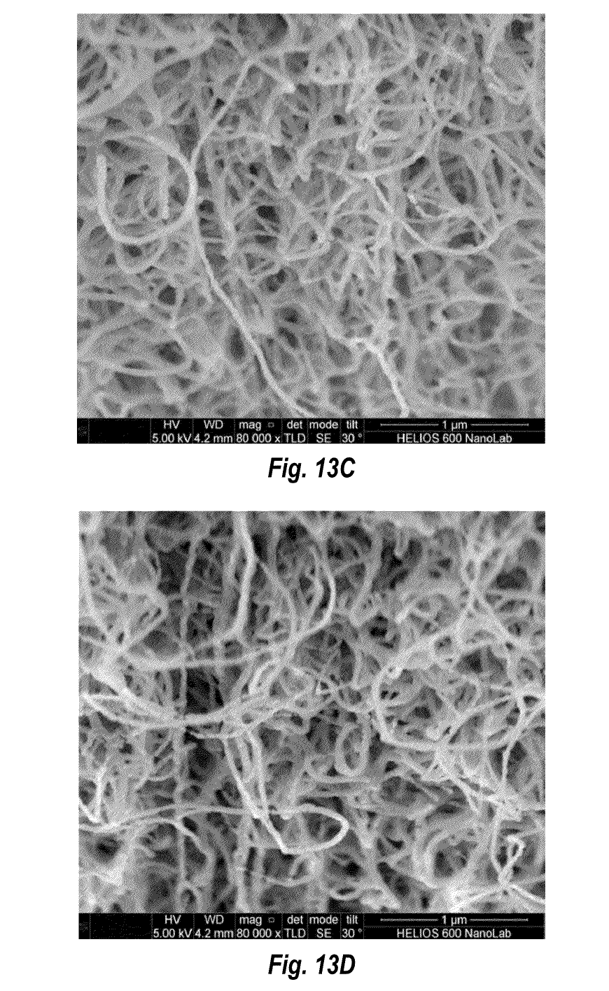

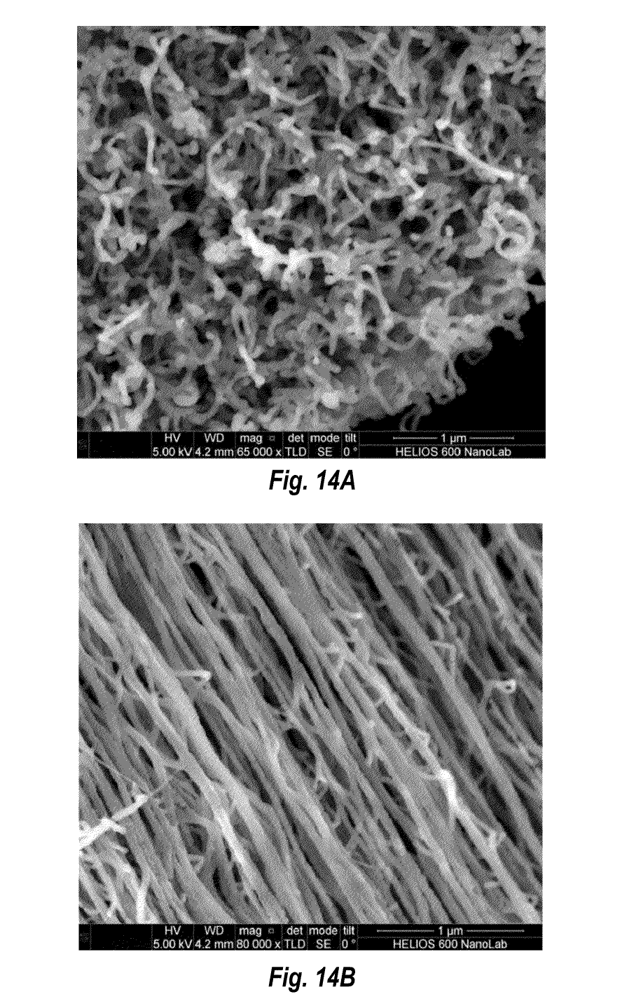

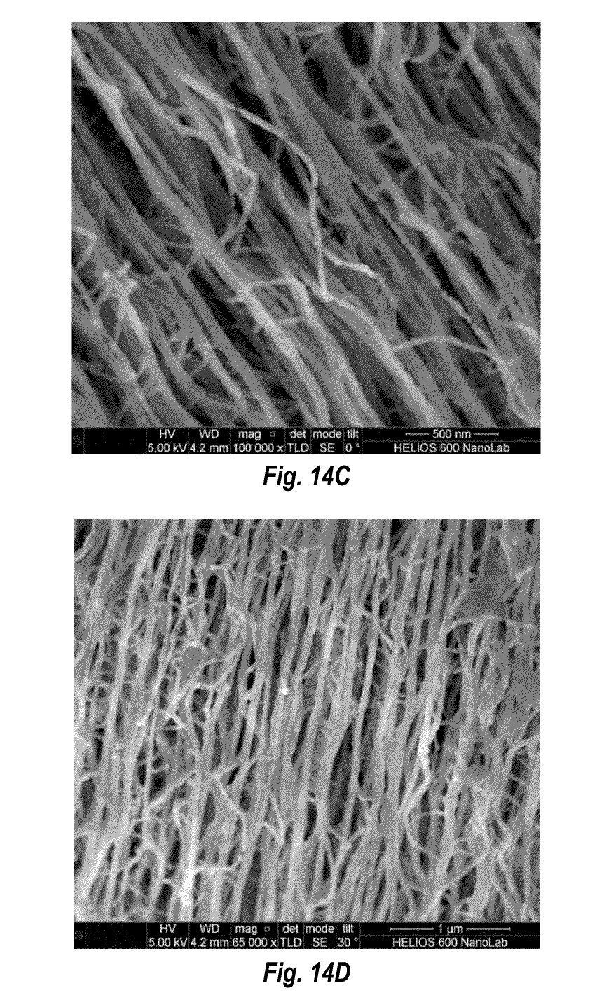

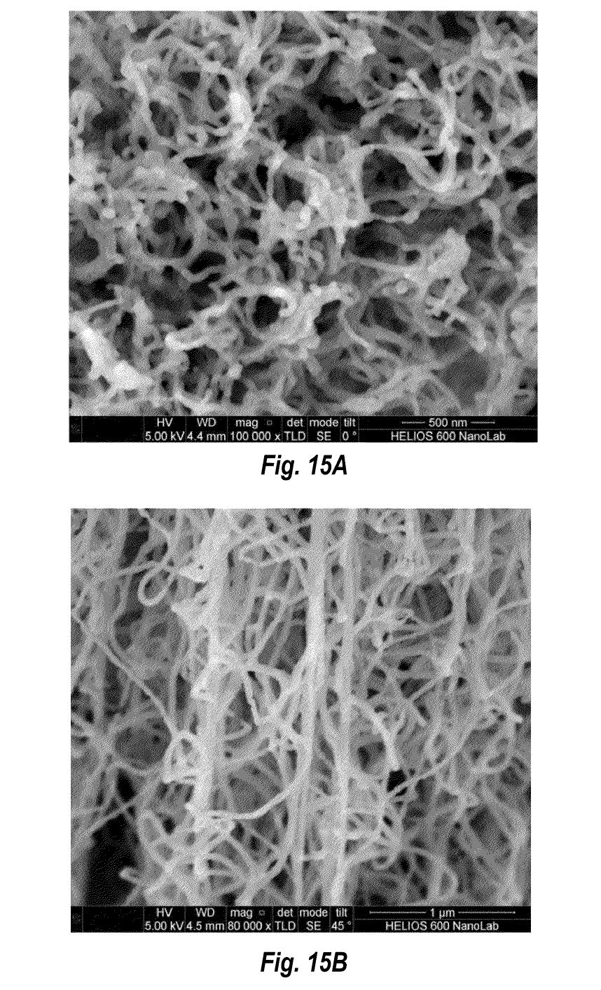

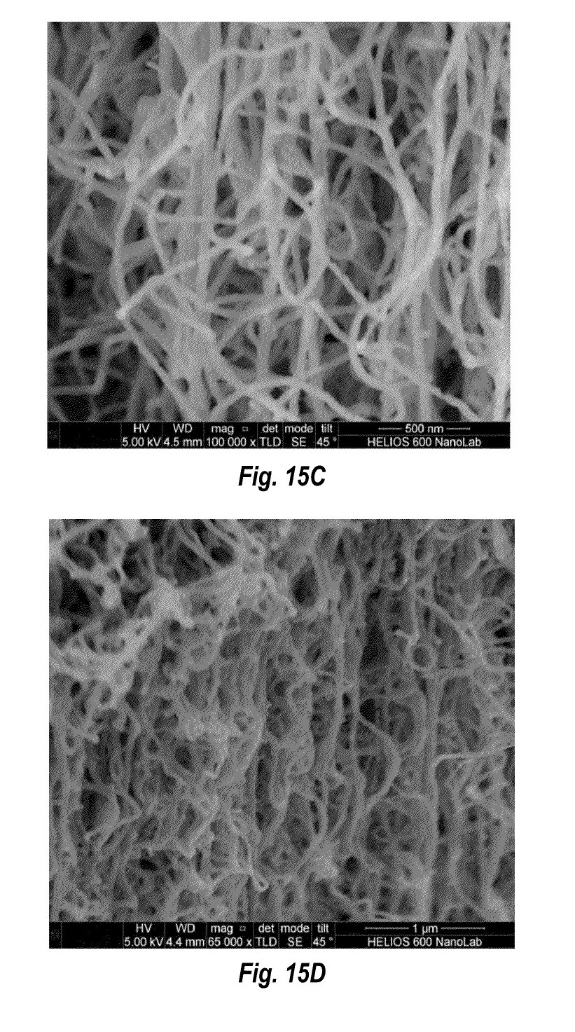

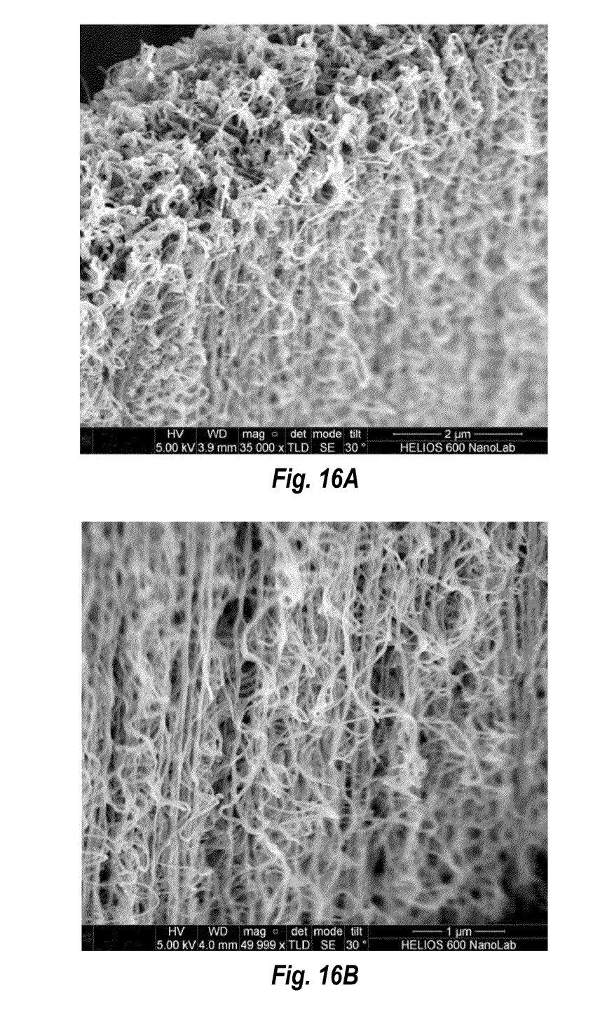

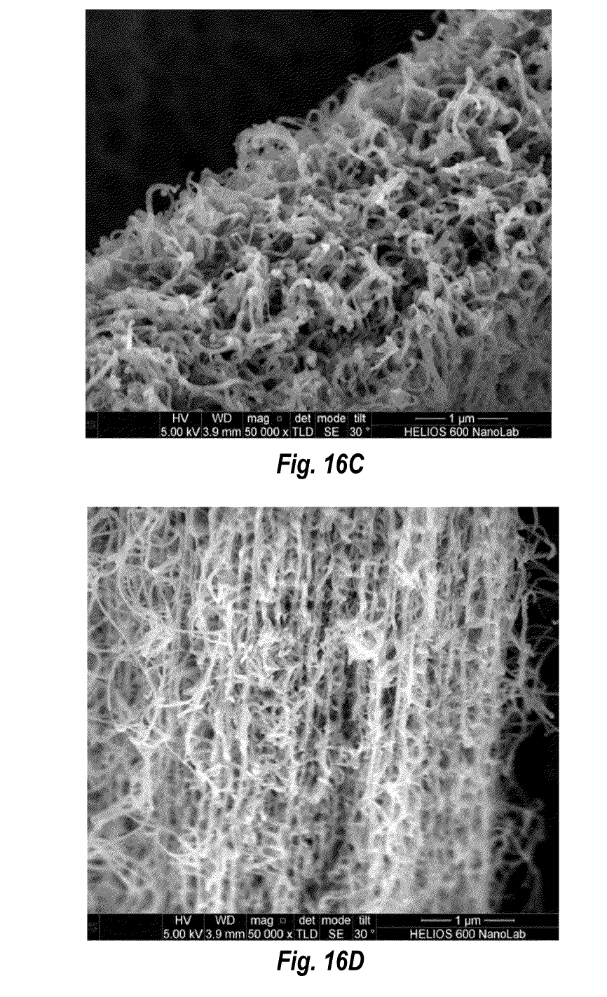

FIGS. 13A-16D show the effectiveness of various ozone treatment regimes, each allowing for subsequent good quality conformal coating of the CNTs with silica by pseudo-ALD. For example, FIGS. 13A-13D show SEM images of silica deposited CNTs surface treated with ozone by exposure to UV lamp for 15 minutes. FIGS. 14A-14D show SEM images of silica deposited CNTs surface treated with ozone by exposure to UV lamp for 45 minutes. FIGS. 15A-15D show SEM images of silica deposited CNTs surface treated with ozone by exposure to ozone generated with a commercial ozone generator for 15 minutes, and FIGS. 16A-16D show SEM images of silica deposited CNTs surface treated with ozone by exposure to ozone generated with a commercial ozone generator for 45 minutes. SEM images were captured with an FEI Helios Nanolab 600 (Hillsboro, Oreg.).

Once ozone treatment or other oxidation process has been performed, CNTs 106 may be infiltrated with a stationary phase or stationary phase precursor. Referring to FIG. 10D, after growth, CNTs 106 may be infiltrated with one or more infiltrants (e.g. a precursor gas) so that a coating 108 deposits on oxygen rich surface 116′ adjacent the CNTs 106. FIG. 10DD shows a close up transverse cross-sectional view through a single CNT 106, showing formation of stationary phase 108 (or precursor thereof) over oxygen enriched surface 107.

Coating 108 comprises a stationary phase and/or a precursor to the stationary phase. Examples of materials for coating 108 include, but are not limited to, elemental silicon (e.g., deposited from a precursor SiH₄ gas), silicon dioxide, silicon nitride, elemental aluminum, aluminum oxide, elemental zirconium, zirconium oxide (e.g., zirconium dioxide), elemental titanium, titanium oxide, amorphous carbon, graphitic carbon, and combinations of the foregoing. Because the choice of coating 108 may change the selectivity of the resulting TLC plate, coating 108 used for manufacture of any given TLC plate may be selected depending on the intended use of the TLC plate.

In an embodiment, infiltration of CNTs 106 may be accomplished using chemical vapor deposition (e.g., low pressure chemical vapor deposition (“LPCVD”)) or another suitable deposition process (e.g., ALD or pseudo-ALD). Silica may be directly deposited by cycling trimethylaluminum (“TMA”) and tris(tert-butoxy)silanol (((CH₃)₃O)₃SiOH) (“TTBS”) in a serial, repeating (e.g., in an ABAB fashion) fashion. For example, where depositing silica, the TLC plate intermediate structure shown in FIG. 10B may be placed into a furnace and heated from about 150° C. to about 350° C., more particularly from about 200° C. to about 300° C., and even more particularly from about 225° C. to about 250° C. (e.g., about 235° C.). Under such conditions, the TMA/TTBS reactants flow over ozone treated CNTs 106 to cause a coating 108 (see FIG. 10D) of silica to form on CNTs 106. A thickness of about 5 nm to about 15 nm per cycle can be achieved, for a final silica thickness of about 50 to about 125 nm (e.g., about 70 nm) after a desired number of cycles (e.g., 8-10 cycles).

When depositing silicon (which is later oxidized to silica), the TLC plate intermediate structure shown in FIG. 10B may be placed into a furnace and heated to about 500° C. to about 650° C., more particularly between about 540° C. to about 620° C., and even more particularly to between about 560° C. to about 600° C. (e.g., about 580° C.). During infiltration, the infiltration pressure may be maintained at less than about 400 mTorr. For example, the infiltration pressure may be maintained between about 50 mTorr and about 400 mTorr, more particularly between about 100 mTorr to about 300 mTorr, and even more particularly to between about 150 mTorr to about 250 mTorr (e.g., about 200 mTorr). The amount of deposition of the coating material achieved may be affected by process time. For example, process time for silicon infiltration may be between about 0.5 hours and about 10 hours, more particularly between about 1 hours and about 5 hours, and most particularly between about 1 hours and about 4 hours (e.g., about 3 hours).

Amorphous carbon infiltration of the CNTs 106 may be performed using a carbon source flowing through the fused silica tube at elevated temperatures. For example, ethylene may be flowed, for example, at a rate of 170 cm³/min mixed with argon at a flow rate of 200 cm³/min and at a temperature of about 900° C. Due to the light absorptive characteristics of amorphous carbon, the detection of analytes after separation may require a post sample preparation. This process may include marking the analytes with an oxidation stable marker and removing the carbon in a high temperature oxygen environment (e.g., with an oxygen plasma). For example, the developing agent may comprise silane, either in the gas phase or in solution, which would be applied to the TLC plate. In an oxidative environment (e.g., an oven, a plasma, or flame), the carbon would be burned away leaving a pattern of SiO₂ that would reveal where migration of analytes had occurred.

A stationary phase may be directly deposited to ozone treated CNTs 106. For example, deposition processes for SiO₂ include direct SiO₂ LPCVD, ALD, or by other CVD processes with SiH₄ and O₂ or SiH₂Cl₂ with N₂O, or by other methods for CNT infiltration that will be apparent to one of skill in the art in light of the present disclosure. The inventors successfully have performed deposition of silica directly onto the ozone treated CNTs using pseudo-ALD.

ALD processes may be used to infiltrate CNTs 106 with a coating (e.g., a conformal coating) of a selected material having chromatographic abilities, or which may be subsequently processed to result in such abilities. The above-described pseudo-ALD process enables deposition of a relatively very thick layer of silica in a single cycle (e.g., about 5 nm to about 15 nm per cycle). Other similar processes may alternatively be used. For example, ALD may be used to infiltrate CNTs with SiO₂. One such process may use SiCl₄ and water at a selected temperature. SiCl₄ is introduced into the chamber containing CNTs 106 and is allowed to react therewith for a predetermined time. After finishing the self-limiting chemisorptions/physisorption process, which may include removing most of the silicon precursor (SiCl₄), water is introduced into the chamber which reacts with the bound SiCl₄ to produce a conforming layer of SiO₂ on CNTs 106. Most, or all, of the water in the chamber may then be removed. This process is repeated until a predetermined film thickness of SiO₂ is achieved. Such an ALD process may be significantly slower, providing only a ca. 0.1 nm thickness of silica deposition per cycle. Thus, the pseudo-ALD process may be faster, as it provides 50 to 150 times greater deposition per cycle.

Other ALD-like processes are also possible. Another ALD-like process may include introduction of SiCl₄, but excess SiCl₄ may or may not be entirely removed by pumping before water is introduced. In turn, excess water may or may not be entirely removed before SiCl₄ is introduced. By not entirely removing excess reagent, as would be appropriate for a true ALD process, faster deposition of SiO₂ may be possible. This same strategy of incomplete removal of material could be contemplated for other ALD chemistries that could be used to infiltrate CNTs 106. It is also noted that perfect conformal coating of uniform thickness of CNTs 106 may not always be desirable. An infiltration process may be designed to produce a rough non-uniform thickness coating so as to increase the surface area of the support.

In another embodiment, CNTs 106 may be infiltrated with elemental silicon by LPCVD and then oxidized, if needed or desired, to form SiO₂. For example, silicon infiltration may be achieved by flowing SiH₄ at a rate of about 20 cm³/min at a temperature of about 530° C. with a pressure of about 160 mTorr for about 1-3 hours, depending on film thickness (degree of infiltration) desired. After the silicon deposition, the material may be placed into a furnace in air and treated to between about 500° C. and about 1000° C. (e.g., about 850° or 900° C.) for between about 1 and about 10 hours. This process converts the elemental silicon to silicon dioxide, while also removing CNTs 106 by oxidizing them into CO and/or CO₂ thereby leaving elongated stationary phase structures made from silicon dioxide without any significant amount of CNTs 106 filling. In additional embodiments, the CNTs 106 may not be removed or they may only be partially removed.

Direct deposition of silica may be advantageous for one or more reasons, one of which is that the oxidizing step for removal of CNTs can be achieved at lower temperature (e.g., not more than 650° C., from about 500° C. to about 650° C., or about 600° C.) than where oxidation of the stationary phase precursor is also required. Depending on the extent of the oxidation process, the elongated stationary phase structures may be substantially solid nanowires without a hollow central portion where the CNTs 106 where present. This process may produce a white and/or transparent SiO₂ material that may be used for chromatography. Silicon infiltration between and around the CNT wires may be nearly complete (e.g., at least about 90%).

In the case in which the infiltrant is a silicon precursor gas such as silane, coating 108 may be silicon. However, as discussed above, other precursor gases may be used so that coating 108 may be formed from aluminum or zirconium, or oxides thereof (e.g., use of TMA/TTBS results in a coating of silicon dioxide). Depending on the infiltrant selected, coating 108 may at least partially or substantially coat the entire array of ozone treated CNTs 106 only, or it may also coat the intervening portions of backing layer 102 and catalyst layer 104 between the CNTs 106, resulting in a TLC plate that is one coherent mass.

Coating 108 on respective primed CNTs 106 shown in FIG. 10D forms respective high aspect ratio structures exhibiting an elongated annular geometry (e.g., a substantially hollow cylinder). Ozone treated CNTs 106 act as templates around which the coating material deposits. In some embodiments, coating 108 may be porous or non-porous. The particular aspect ratio of the elongated structures made from coating 108 depends on the height of the template CNTs 106, the deposition time, the process temperature (e.g., temperature of infiltrant and of CNTs 106), or combinations of the foregoing process parameters.

An average aspect ratio (i.e., ratio of average length to average diameter) of the plurality of elongated structures defined by coating 108 coating respective CNTs 106 may be about 10,000 to about 2,000,000, such about 10,000 to about 1,000,000, or about 100,000 to about 750,000. The average radial thickness of coating 108 coating the CNTs 106 may be about 10 nm to about 250 nm, more particularly about 20 nm to about 150 nm, and even more particularly about 50 nm to about 125 nm (e.g., about 50 to 100 nm). The average length of the elongated structures defined by coating 108 may be substantially the same or similar as the template CNTs 106.

In some cases, random growth of CNTs 106 followed by infiltration and optionally oxidation of coating 108 can pose a potential problem. During the oxidation process of converting silicon to silicon dioxide, the material undergoes a volume expansion due to the addition of the oxygen. The volume expansion may cause the material to delaminate from the backing, particularly during longer, more complete oxidation times and at relatively higher oxidation temperatures. Even if delamination does not appear to have occurred initially, the material may easily buckle and flake away as a result of a slight bump or touch because of the expansion. One way to reduce, minimize, or eliminate such delamination, flaking, or buckling of the material from the backing is by patterning (e.g., zigzag or other non-linear) the CNT growth catalyst, which places voids into the overall structure allowing for volume expansion during the oxidation step. In addition, patterning of the stationary phase medium on the micron-scale may improve separation efficiency. Another way to reduce minimize or eliminate such undesirable characteristics is by directly depositing a stationary phase material (e.g., silicon dioxide) rather than depositing a stationary phase precursor that is later oxidized.

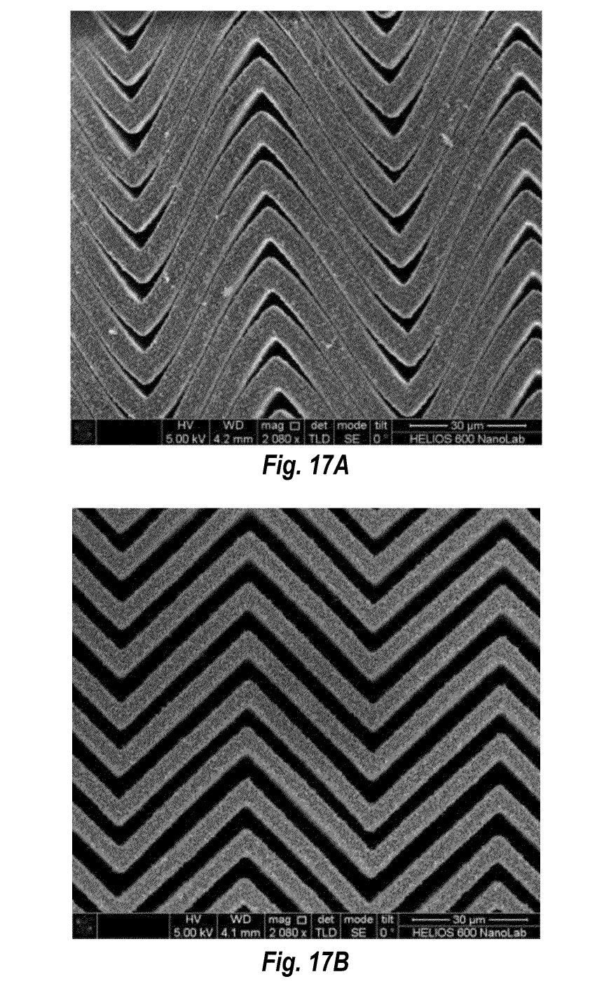

In addition, ozone treatment of the CNTs prior to infiltration may further aid in reducing, minimizing, or eliminating such distortion. Furthermore, ozone treatment allows direct deposition of the stationary phase (e.g., silicon dioxide), without the need for any priming layer(s), and rather than requiring deposition of a precursor (e.g. silicon) that is later oxidized. Thus, in at least some embodiments, the oxidation step (e.g., to remove the CNTs) is not required to oxidize silicon to silicon dioxide, and can be achieved at a lower temperature than where the oxidation step also oxidizes the silicon to silicon dioxide. FIG. 17A illustrates an SEM image of a TLC plate prepared without ozone treatment and without priming of the CNTs, and in which the oxidation step oxidized deposited silicon to silicon dioxide. As readily seen, some distortion is visible where the flow channels between adjacent hedges substantially close at a mid-section of each hedge (i.e., furthest from where the 90° angle bend of the zig-zag occurs). FIG. 15B illustrates an SEM image of a TLC plate fabricated with the use of priming layers and with deposition of silicon dioxide onto the primed CNTs, so that the oxidation step was not required to oxidize a deposited silica layer to silicon dioxide. TLC plates fabricated without the use of priming layers, where the priming layer steps are replaced with ozone treatment or other oxidation process exhibit a similar appearance (i.e., good mechanical stability and the absence of distortion of the zigzag pattern). Replacement of the priming step with ozone treatment or other oxidation process may result in a significantly simplified manufacture process, with comparable, if not superior, results.

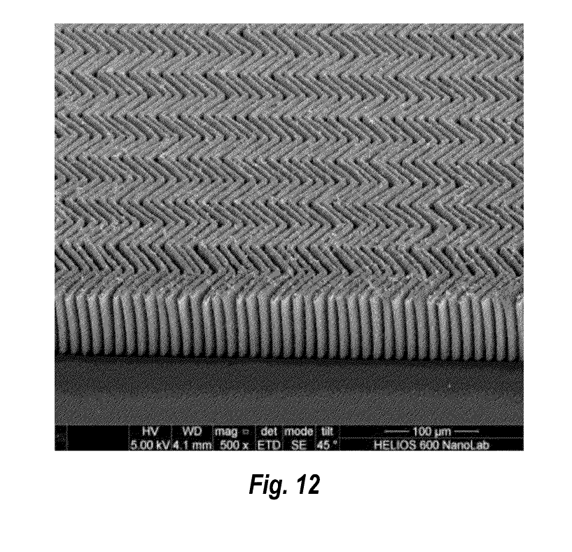

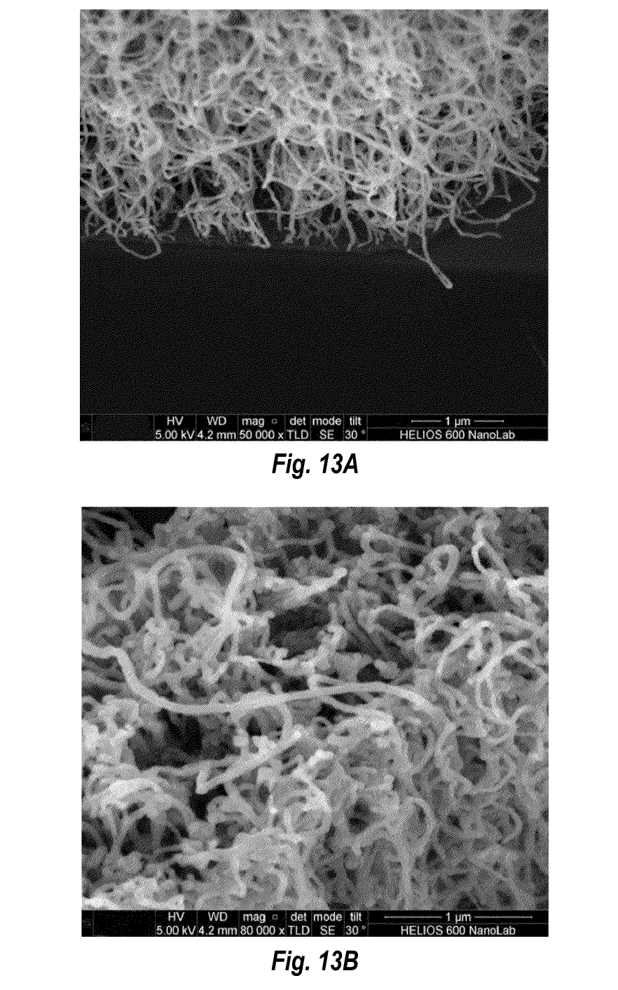

The selected zigzag pattern may include any of various angles of greater than 0° and less than 180° between the particular portions of the zigzag. For example, the zigzag patterns shown in FIGS. 1, 2, 11A, 11B, 12, 17A, and 17B may exhibit an angle of about 70° to about 90° between adjacent portions of the zig and zag of the pattern.

As described above, an average bed spacing between adjacent portions of patterned catalyst layer 104 may be from about 0.25 μm to about 50 μm, more particularly from about 2 μm to about 20 μm, and most particularly from about 5 μm to about 15 μm (e.g., about 10 μm). This spacing could be described as distance center to center from one “hedge” to another. The “hedge” width may be from about 0.25 μm to about 15 μm, from about 2 μm to about 10 μm, or from about 3 μm to about 8 μm (e.g., about 3 μm to about 4 μm). The growth of CNTs 106 followed by infiltration with infiltrant and/or growth of coating 108 around CNTs 106 results in less spacing between adjacent elongated structures defined by coating 108 as they grow laterally outward and towards one another.

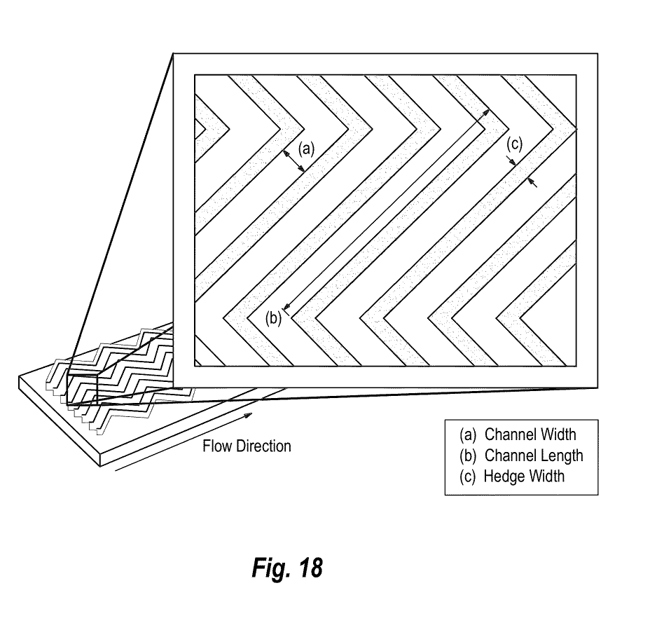

For example, an average spacing between adjacent elongated structures (i.e., “flow channel” width) defined by coating 108 may be between about 0.5 μm and about 30 μm, more particularly between about 2 μm and about 10 μm, and most particularly between about 4 μm and about 8 μm (e.g., about 4 μm to about 6 μm). Such spacing results in a bulk structure having very high bulk porosity i.e., the spacing between adjacent structures act as pores through which the mobile phase and sample carried therewith advance as a result of capillary action. In one embodiment, the flow channel width may be greater than the hedge width (e.g., about 5 μm versus about 4 μm, about 4 μm versus about 3 μm, about 5 μm versus about 3 μm, about 6 μm versus about 3 μm, or about 5 μm versus about 4 μm). Flow channel length may be from about 5 μm to about 500 μm, about 10 μm to about 100 μm, or about 25 μm to about 75 μm. When present, porosity of any individual coating 108 (i.e., as opposed to bulk porosity resulting from spacing between adjacent structures) may also contribute to the overall porosity TLC plate. Flow channel width “a”, channel length “b”, and hedge width “c” for an exemplary zig-zag pattern are clearly shown in FIG. 18.

In an embodiment, CNTs 106 may be partially or substantially completely removed once the coating 108 has been deposited onto CNTs 106. For example, the TLC plate intermediate structure shown in FIG. 10D may be placed into a furnace and heated in the presence of an oxidizing atmosphere (e.g., an oxygen atmosphere) so as to remove (e.g., burn off) substantially all of CNTs 106, leaving only coating 108 disposed on the backing layer 102 and catalyst layer 104 of TLC plate substrate 101. In some embodiments, the stationary phase coating 108 does not require further oxidation prior to use (e.g., it is deposited as silica rather than silicon).

In other embodiments, such an oxidation step may also serve to convert coating 108 into the stationary phase by oxidizing the as-deposited coating 108 if it is not already a chromatography capable stationary phase. For example, if coating 108 is silicon, aluminum, or zirconium, it may be oxidized to silicon oxide, aluminum oxide, or zirconium oxide, respectively. An embodiment of a method for removal of the CNTs 106 may include oxidizing coating 108 using an oxygen plasma. Other methods for at least partially removing CNTs 106 may include dissolution of CNTs 106, or removal by any method.

Where the oxidation step also oxidizes the as deposited coating 108 into an oxide stationary phase, the temperature may need to be higher than where the oxidation step is not required to oxidize the deposited coating. For example, where the coating is oxidized during the oxidation step, the temperature may be from about 800° C. to about 900° C. (e.g., about 850° C. to 900° C.). Where the oxidation step is not required to oxidize the coating 108 (e.g., because coating 108 was already deposited as a desired oxide such as silicon dioxide), the temperature may be substantially lower (e.g., not more than about 750° C., not more than about 700° C., not more than about 650°, not more than about 600° C., or from about 500° C. to about 650° C., or about 600° C.). Methods that deposit coating 108 as an oxide rather than a precursor to an oxide stationary phase may be beneficial, as the lower processing temperature may further increase the mechanical stability of the resulting stationary phase of a TLC plate. In other words, because of the lower temperature and the fact that no oxidizing of the coating 108 occurs during the oxidation step, less distortion of the zig-zag or other pattern may occur, providing increased mechanical stability and durability.

FIG. 10E is a cross-sectional view of the structure shown in FIG. 10D in which the CNTs 106 have been removed. FIG. 10EE is a close up cross-sectional view of stationary phase structures 108′ once CNTs 106 have been burned off. FIG. 10E clearly shows the overall high aspect ratio configuration of the stationary phase structures 108′. The dimensions of the plurality of elongated stationary phase structures 108′ may be substantially the same or similar dimensions as the plurality of elongated structures defined by coating 108 prior to oxidation of CNTs 106. The oxidation process may occur for at least about 5 hours, more particularly at least about 10 hours, and most particularly for at least about 15 hours. Somewhat reduced processing times may be provided where oxidation of the coating 108 is not required (e.g., about 15 to about 24 hours is typically sufficient).

As shown in FIGS. 10E and 10EE, in embodiments in which the coating 108 is deposited by ALD or an ALD-like process (e.g., ALD deposition of silicon oxide), the resultant elongated stationary phase structures may be hollow elongated cylinders, with the hollow being where a CNT 106 was located. Where the oxidation step also oxidizes coating 108, depending on the extent of the oxidation process, the elongated stationary phase structures 108′ may be substantially solid nanowires in which the space previously occupied by the CNTs 106 is consumed or filled by the oxide.

Removal of CNTs 106 before use of the TLC plate may prevent CNTs 106 from interfering (e.g., through a secondary interaction) with separation of an analyte mixture during use of the TLC plate. In addition, it results in a white and/or transparent stationary phase; thereby making evaluation of the chromatography results easier than if the stationary phase is black or brown. In embodiments in which the coating 108 comprises amorphous carbon, the CNTs 106 may not be removed, as both the coating 108 and CNTs 106 comprise carbon, thereby substantially eliminating the possibility of a secondary interaction as a result of the CNTs 106 being present in the stationary phase formed during infiltration.

In a similar manner, it can be desirable, in some embodiments, that the coating 108′ substantially fully coats and covers any adhesion priming layer(s). Any amorphous carbon priming layer may simply be burned away with the CNTs, while an alumina priming layer may remain after the oxidation step. In embodiments without any alumina priming layer, the absence of the alumina priming layer can be advantageous because exteriorly exposed alumina may interfere with the separation results achieved by the TLC plate. That said, where the pseudo-ALD deposition of silica may involve the use of an aluminum compound (e.g., TMA), it may be beneficial to further hydrate the stationary phase surface with silanol groups and to apply an amino silane or other silane to coat any exposed aluminum sites, as will be discussed in further detail below.

In some embodiments, the stationary phase structures 108′ comprise a material that is white, off white, transparent, or generally light in color so that the compounds of the mobile phase separated during use of the TLC plate are visible on the surface of the TLC plate after being developed. Silicon and/or silicon dioxide are examples of materials that provide such a color contrast. In some embodiments, a fluorescent material (e.g., ZnS) may be incorporated in the TLC plate to produce a fluorescently active TLC plate. This may be accomplished by depositing a thin film on top of or a few monolayers beneath the chromatographic support. This may be done either in the liquid or gas phase. ALD, along with other CVD or liquid phase processes, can be used to place inorganic species into or onto the chromatographic support. For example, the fluorescent material may at least partially coat and/or may be incorporated in the stationary phase structures 108′, may at least partially coat intervening portions of backing layer 102 between the stationary phase structures 108′, or both. In an embodiment, the fluorescent material may be provided by depositing nanoparticles of a fluorescent inorganic material from a solution or slurry.

After oxidation and removal of CNTs 106, in some embodiments, the TLC plate may be exposed to at least one acid (e.g., HF) or base (e.g., NH₄OH) to hydrate the stationary phase structures 108′. For example, the TLC plate so formed may be placed in a furnace in the presence of HCl or other acid (or base) so that HCl (or other) vapors result in placement of hydroxyl or silanol groups onto the surface of stationary phase structures 108′ to functionalize stationary phase structures 108′. Additional chemical functionality and selectivity may be added to the stationary phase structures 108′ by, for example, silanolization with alkyl moieties through any suitable gas phase chemistry. When the stationary phase structures 108′ comprise silica, the silica may also be functionalized by bonding C₈ to C₁₈ chains (e.g., C₈ chains, C₁₈ chains), NH₂, or combinations thereof to the silica.

For example, the TLC plate may be immersed in an acid solution for a selected time period. In an embodiment, the acid solution may comprise 50:50 vol./vol. concentrated HCl and methanol and the TLC plate may be heated therein to reflux temperatures for several hours (e.g., 4-20 hours). The methanol in the acid solution may aid in surface wetting. Other acids that may be used, such as nitric acid, HBr, HF, acetic acid, formic acid, trifluoroacetic acid, or combinations thereof. Exposure to the HCl vapors or introduction of water vapor or acidified water vapor (including the above mentioned acids, or other suitable acids) into the oxidizing chamber while the material is being cooled or for a predetermined time at an elevated temperature may increase the number of hydroxyl groups on the silica surface of the stationary phase structures 108′. Bases such as NH₄OH may similarly be employed to hydrate the surface.

In an embodiment, the stationary phase may be exposed to water vapor after the oxidation step and during cooling from the oxidation temperature to ambient temperature. Acidified water vapor may be employed to hydroxylate the surface. For example, this may be done by placing the TLC plate above a boiling HCl solution so that the vapors of the solution are allowed to interact with the stationary phase. The heated solution may include methanol to aid in surface wetting. Other components that may be used include other strong acids (e.g., nitric acid, HBr, HF), organic acids (e.g., acetic acid, formic acid, trifluoroacetic acid) or other suitable chemical that can hydroxylate the surface. In one embodiment, exposure may be about 5 minutes, although shorter or longer times may be employed.

Where a base is used, the stationary phase may be immersed in the base etching solution at room temperature for a period of about 12 to about 24 hours (e.g., about 18 hours). Exemplary bases that may be suitable include ammonium hydroxide, calcium hydroxide, sodium hydroxide, potassium hydroxides, other hydroxide salts, or combinations thereof.

The silanol containing surfaces may be silanized using a wide variety of silanes (e.g., mono-chlorosilanes, di-chlorosilanes, tri-chlorosilanes, or combinations thereof). Examples of suitable silanes include alkyl silanes (e.g., octadecyl trichlorosilane, octadecyldimethylchlorosilane, perfluoro alkyl silanes), amino silanes, phenyl silanes, cyano silanes, biphenyl silanes, or combinations thereof. Such silanes may be monofunctional (e.g., including one Si—Cl group, one Si—OCH₃ group, one Si—OCH₂CH₃ group, or one Si—OC(O)CH₃ group), or silanes bearing more than one surface reactive functional group. Molecules such as octadecyldiisopropylchlorosilane are contemplated, where the isopropyl groups impart added hydrolytic stability to the silica TLC plate.

In an embodiment, the stationary phase may be treated by deposition of an amino silane (e.g., 3-aminopropyltriethoxysilane (“APTES”)) to better cover reactive or acidic sites on the surface of the stationary material. Other silanes such as those identified above may also be employed. Such treatments may result in an improvement in the chromatographic performance of the material.

In an embodiment, the TLC plates may be produced with a concentration zone. This involves having an area that has relatively low retention where compounds may be spotted. This allows for the mobile phase to quickly pull the analyte through this area and then the analytes will slow down when they reach the normal sorbent bed. This can be done by making the pre-concentration area with a low density of the stationary phase structures and/or selectively functionalizing this area with a chemical species that allows for reduced retention of analytes.

In some embodiments, substrate 101 may be scribed or partially cut before or after growth of CNTs 106 and/or coating CNTs 106. By scribing or cutting substrate 101, smaller TLC plates may be fabricated by breaking a larger TLC plate along a scribe/cut line of substrate 101.

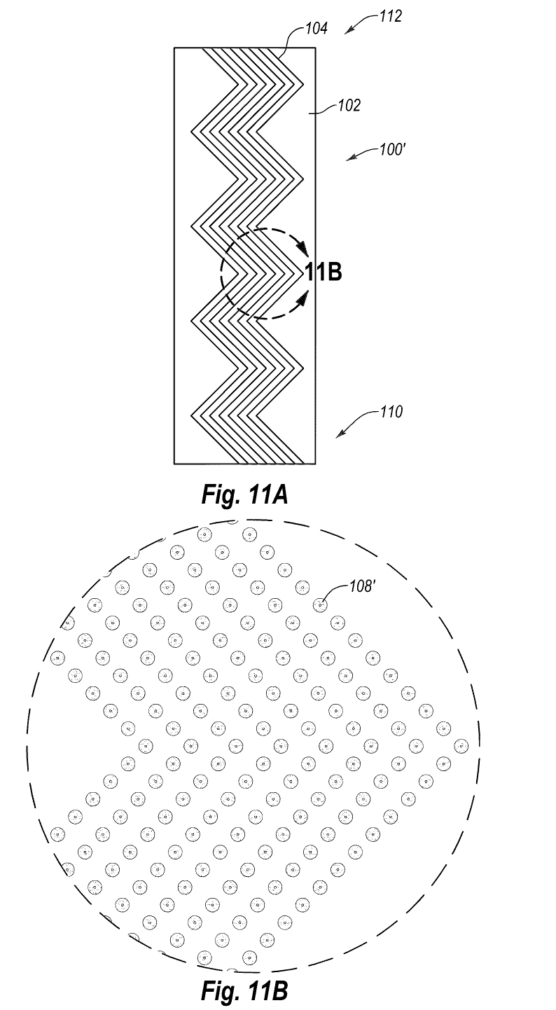

FIG. 11A is a top plan view of an embodiment of a TLC plate 100′. FIG. 11B is a close-up view of a portion of TLC plate 100′ includes stationary phase structures 108′ that are arranged between an end 110 and an end 112 of TLC plate 100′. TLC plates prepared according to the inventive methods disclosed herein provide a stationary phase in which the stationary phase is affixed to the substrate of the TLC plate without the use of any separate binding agent (e.g., calcium sulfate or a polymer). Such binding agents can interfere with the performance of the TLC plate as the result of secondary interactions resulting from the binding agent. The reduction or the elimination of any binding agent may result in a more high efficiency TLC plate, while minimizing and/or preventing such secondary interactions.

The spacing of the stationary phase structures 108′ is illustrated in FIGS. 11A and 11B as being generally uniform. However, in some embodiments, the density of the stationary phase structures 108′ may be different (e.g., greater or less) in different locations of the TLC plate 100′. For example, the density of the stationary phase structures 108′ may be different (e.g., greater or less) near end 110 than near end 112. Additional structures 108′ may fill the smaller space between adjacent structures 108′ in a given hedge so that each hedge is substantially continuous. Each hedge is separated from an adjacent hedge by a flow channel therebetween (e.g., as shown in FIG. 18). As an alternative to or in addition to the density of the stationary phase structures 108′ varying with location, the composition of the stationary phase structures 108′ may vary with location. As a non-limiting example, one portion of the stationary phase structures 108′ may comprise zirconium oxide and another portion of the stationary phase structures 108′ may comprise silica.

Furthermore, TLC plates prepared according to the inventive methods disclosed herein provide a stationary phase having a particularly high porosity. The high porosity, as well as the absence of a binder may result in increased efficiency of the TLC plate during use in analyzing a sample within a mobile phase. In one embodiment, the TLC plates formed according to the disclosed methods are used to analyze a sample material. In an embodiment, the sample to be analyzed is applied to the stationary phase structures 108′ of TLC plate 100′ (e.g., near end 110). A mobile phase solvent or solvent mixture is then drawn along TLC plate 100′ (e.g., upwardly) by capillary action (e.g., by placing TLC plate 100′ in a container including the solvent or solvent mixture), or the mobile phase solvent or solvent mixture by be forced through TLC plate 100′. As the solvent or solvent mixture is drawn along the TLC plate 100′ via capillary action toward opposite end 112, the sample is dissolved in the mobile phase and separation of components within the sample is achieved because different components of the sample ascend the TLC plate 100′ at different rates. The high aspect ratio stationary phase structures 108′ as well as the bulk porosity as a result of the spacing between individual high aspect ratio stationary phase structures 108′ results in excellent separation efficiency of components within the sample as the sample components are carried through the stationary phase structures 108′ by the mobile phase (e.g., a solvent or solvent mixture). The TLC plates 100′ may also be used in HPTLC in which one or more of the method of use steps may be automated so as to increase the resolution achieved and to allow more accurate quantization.

### III. Working Examples

The following working examples are for illustrative purposes only and are not meant to be limiting with regards to the scope of the specification or the appended claims. Example 1 is representative of how the CNT structures were grown for all examples carried out.

### Example 1

The masks for photolithography were all based on a zig-zag geometry with 90° angles. Silicon wafers (University Wafers, South Boston, Mass.), 4″ diameter, were used as the backing material. A thin film of photoresist, AZ-3312-F (AZ Electronic Materials USA Corp, Somerville, N.J.), was spin coated onto the wafer. The resulting wafer was patterned via photolithography (Karl Suss Mask Aligner, Vermont, USA), followed by e-beam evaporation (Benton Vacuum E-beam Evaporator, Moorestown, N.J.) of a thin barrier layer of alumina (35 nm), and thermal evaporation (custom-built apparatus) of a few nanometers of iron (6 nm). The iron deposition was monitored using a quartz crystal device. The photoresist was then lifted off with a resist stripper (Micropsoit 1165, MicroChem, Newton, Mass.), leaving a pattern of Al₂O₃/Fe at the surface.

The photolithographically patterned wafer was loaded into a fused silica tube (22 mm ID), preheated at 200° C. in a Lindberg/Blue M tube furnace (Thermo Electron Corporation, Marietta, Ohio), and then heated to 400° C. under flow of argon. The temperature was then raised from 400° C. to 750° C. in an atmosphere of hydrogen (400 seem) to reduce iron to its elemental form and substantially simultaneously produce iron nanoparticles. CNTs were grown for 2 minutes at 750° C. to a height of about 50 μm with ethylene (Grade 5.0, 99.999% from Air Gas) at 1000 sccm and hydrogen (Air Gas), at 400 sccm. The material was cooled under an atmosphere of argon to 200° C.

### Example 2

To increase the surface oxygen content of CNT forests for pseudo-atomic layer deposition (pseudo-ALD), a mild, room temperature treatment with ozone was performed. CNTs were ozonated with an Atlas 30 Ozone Generator (Absolute Ozone,
Edmonton, Alberta) at an O₂ flow rate of about 6.7×10⁻⁶ m³/s with the current set at 45%. Under these conditions about 4.4 g/h of ozone is produced. X-ray photoelectron spectroscopy (XPS) was used to determine the extent of oxidation of the CNTs as a function of time. Patterned CNT forests, which were to be used as templates for TLC plates, were loaded into a 1 in. outside diameter fused silica tube that was purged with oxygen for 1 min, exposed to a flow of ozone for 45 min, and finally purged with oxygen for 1 min before removal. The exposure times recorded herein do not include this extra 1 min purge time.

Mild oxidation of CNTs was monitored as a function of exposure time to ozone on unpatterned CNT forests by X-ray photoelectron spectroscopy (“XPS”). XPS is a widely used and sensitive analytical technique for determining surface elemental compositions and oxidation states. Unpatterned CNT forests were used to ensure that no oxygen or silicon signals from the Si/SiO₂ substrate would complicate the XP spectra. Only carbon was observed in the XPS survey spectra of untreated CNTs, and the survey spectra of O₃-treated CNTs showed only carbon and oxygen.

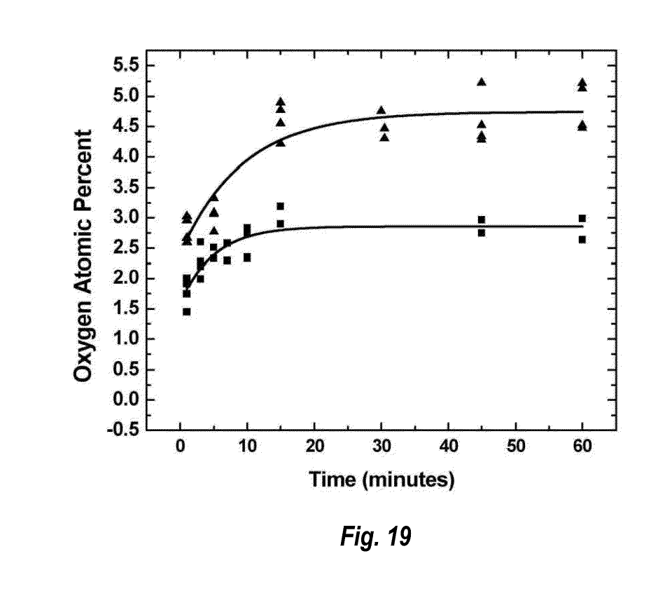

Because of some difficulty in controlling the concentration of ozone delivered by the ozone generator, two experiments were performed on different days in which a series of unpatterned CNT forests were exposed to O₃ for different amounts of time. The percentages of oxygen on these materials were then measured by XPS (see FIG. 19). Relatively quickly, the amount of oxygen increased to reach a plateau after about 20 min. To account for the extra exposure time to O₃ that the CNTs experienced while the reaction tube was flushed with oxygen, the data were fitted to a function of the form a(1−e^{-t/τ})+b. For the data points shown as squares, the R² values for this function were 0.977, a=1.26, and b=1.60. For the data points shown as diamonds, the R² values for this function were 0.965, a=2.31, and b=2.43.

As shown in FIG. 19, even a few minutes of exposure to ozone raised the surface concentration of oxygen on the CNTs to 2-3 atomic percent which is significantly higher than that produced by other deposition techniques. To determine the amount of oxygen needed for good SiO₂ coating by pseudo-ALD, SiO₂ was deposited on ozone-treated CNT forests with a range of atomic percent values of oxygen, as previously measured by XPS. The degree of CNT oxidation resulted from different lengths of exposure with ozone. The resulting plates were evaluated by SEM for structural integrity and by a water immersion stability test (poor quality plates disintegrate in water). From this study it was determined that (1) about 2 atomic percent oxygen, with no other priming, was sufficient for reasonable and conformal pseudo-ALD SiO₂ growth on CNTs; and (2) above this threshold all pseudo-ALD depositions of SiO₂ appear to be equally effective, i.e., no pearl-like features were present and plates were stable to immersion in water, all without the presence of any priming layers.

To move to a region on the curves in FIG. 19 that would clearly give at least 2 atomic percent oxygen, all growth experiments were based on a somewhat longer, but thorough, 45 min ozone exposure. This time of ozonation consistently led to stable TLC plates that passed the water immersion test and gave good chromatographic results.

### Example 3

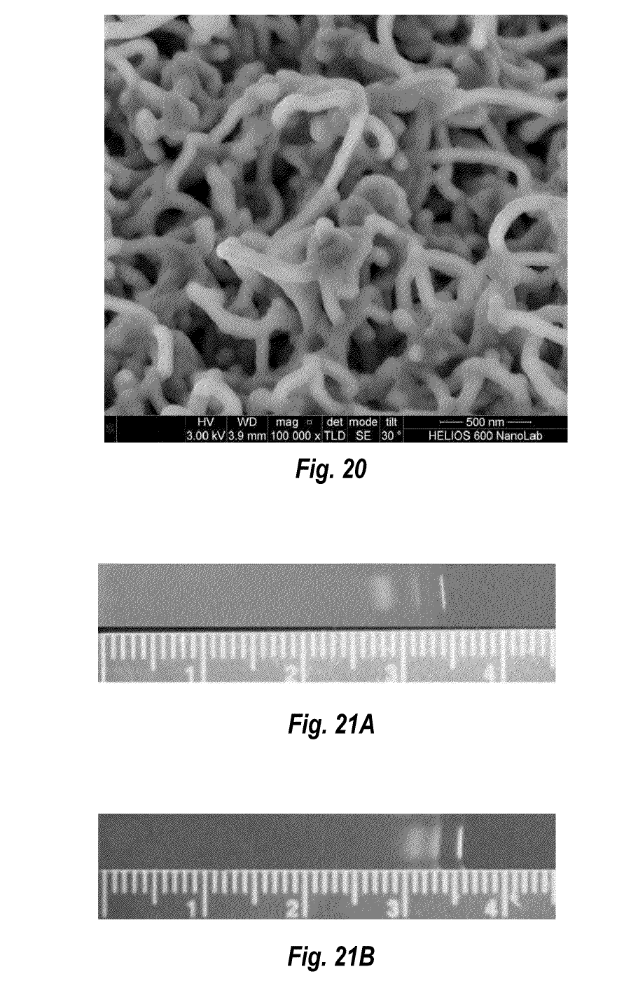

Pseudo-ALD of SiO₂ was performed using a Cambridge Fiji F200 system (Cambridge Nanotechnology, Cambridge, Mass.) with trimethylaluminum (97%, Sigma-Aldrich) and tris(tert-butoxy)silanol (99.999%, Sigma-Aldrich) as half reactants that were cycled in an ABAB type fashion. The deposition took place at 235° C. Ten AB cycles that yielded about 7 nm SiO₂ per cycle (e.g., about 70 nm total) were performed to produce the SiO₂ films. The deposition rate (nm/cycle) may depend on the amount of precursor (tris(tert-butoxy)silanol) present in the reservoir of the deposition system, which may vary between runs and may be somewhat difficult to control. Tube diameters of about 100-120 nm and smooth features/morphologies, as determined by SEM, were obtained. Film thicknesses were also monitored via spectroscopic ellipsometry (M−2000D, J.A. Woollam Co., Inc., Lincoln, Nebr.) using witness silicon wafers. FIG. 20 is a representative SEM “top view” image of a CNT forest after adequate ozone treatment and pseudo-ALD deposition of SiO₂, which shows the high degree of conformality of this process. Note that no pearl-like features are present in this image.

### Example 4

CNTs were removed by air oxidation. It was not necessary to convert Si to SiO₂, so the nanotubes could be burned out at a relatively low temperature (about 600° C.). Silica-coated CNTs were placed in a preheated (200° C.) bench top furnace (Thermolyne 6000 Furnace, Dubuque, Iowa) and heated to 600° C. at 1° C./min. The material was held at this temperature for 17.33 hours for a total processing time of 24 hours. The furnace was then cooled to 200° C. before removal of the samples.

### Example 5

Because removal of CNTs required temperatures above 200° C. the SiO₂ surface was repopulated with silanols. Accordingly, samples were immersed in a pH 10 NH₄OH etching solution for 18 h at room temperature, after which they were rinsed with deionized water to neutrality.

### Example 6

TLC plates were coated with a film of 3-aminopropyltriethoxysilane (APTES) (≧98%, Sigma-Aldrich) having a thickness of about 1.5 nm. APTES covers and/or passivates the SiO₂ surface of the resulting TLC plates. Plates prepared from 4 different masks were used in the working examples. In all cases, a general zig-zag pattern of features (e.g., see FIG. 18) was used. All plates had about 90° angles. The various dimensions of the prepared patterns are shown in Table 1. Channel length “b” was 50 μm for each plate.

TABLE 1

| Plate Type | Hedge Width (c) | Channel Width (a) |
|---|---|---|
| I | 3 μm | 4.24 μm |
| II | 3 μm | 4.95 μm |
| III | 3 μm | 5.65 μm |
| IV | 4 μm | 4.95 μm |

### Example 7

To benchmark the present working examples to the inventor's own previous work, a separation of biological dyes was performed. The efficiencies of plates fabricated using the procedures described herein were higher than before, i.e., H_{obs} (which will be defined below) was often below the about 1.6-7.7 μm (above about 85,000-270,000 N/m) values obtained with previous methods which included formation of priming layer(s) over the CNTs.

A solution of two fluorescent dyes (sulforhodamine B and rhodamine 6G) was prepared by dissolving the analytes in methanol at concentrations of about 10⁻⁷ M. A 1 μL volume of this solution was applied as a 3 mm×0.7-0.8 mm band near the bottom of the TLC plates using a Linomat 5 spotter (CAMAG, Muttenz, Switzerland). The band was applied 5 mm from the bottom of the plate. The plate was then placed in a 10 cm×10 cm twin trough chamber (CAMAG, Muttenz, Switzerland) and pre-equilibrated with the vapors of the developing solvent: 70:30:1 IPA:MeOH:LiCl (v/v/w) for 10 min. After pre-equilibration, 3 mL of the developing solvent was introduced at the bottom of the plate to commence chromatography. The immersion line was 2 mm above the bottom edge of the plate. The TLC plate was developed over a 30 mm distance from the application origin.

For detection of the fluorescent dyes, the TLC plate was exposed to short wavelength UV light (254 nm) (Model UVG-11 Mineralight Lamp, Ultra-Violet Products, Inc., San Gabriel, Calif.). TLC plates were imaged using a digital camera (Canon PowerShot S95, Canon USA, Inc., Lake Success, N.Y.), and images were processed using ImageJ (ImageJ 1.42q, National Institutes of Health, USA).

Retention factors (R_{f}) were calculated with the following equation:

$${R}_{f} = \frac{{Z}_{s}}{{Z}_{f}}$$

where Zₛ is the analyte migration distance from the application origin and Z_{f} is the distance the solvent front traveled also from the application origin. Chromatographic efficiencies were determined by the number of theoretical plates (N) according to:

$$N = 16 {( \frac{{Z}_{f} {R}_{f}}{W} )}^{2}$$

where W is the width of the chromatographic band.

Because of the changing mobile phase velocity in TLC, observed plate heights (H_{obs}) may be a better way of reporting chromatographic efficiency:

$${H}_{obs} = \frac{{σ}_{chrom}^{2}}{{R}_{f} ( {Z}_{f} - {Z}_{o} )}$$

The value of σ²_{chrom} in this equation is calculated from σ²_{obs}=σ²_{chrom}+σ²_{SA}+σ²_{INS} where σ²_{obs} is the observed variance of the band after elution, σ²_{SA} is the variance of the band at the spot application, and σ²_{INS} is the variance of the densitometric measurement (where a densitometer is not used, σ²_{INS} may be estimated to be 0). The value of σ²_{SA} was determined from the initial width of the spot at application (0.7 mm), which was taken as 5σ_{SA}, i.e., σ²_{SA}=0.019₆ mm². The widths of the bands after chromatography are similarly taken as 5σ_{chrom}.

FIGS. 21A and 21B show two separations of two fluorescent dyes on two APTES-coated plates with different geometries (Type II and Type IV, respectively as shown in Table 1). In these separations, the separation distance was 30 mm and the development times were 2 min 20 s (FIG. 21A) and 2 min and 45 sec (FIG. 21B). FIG. 21A shows a β-front observed above the two fluorescent dyes, which originates from the mobile phase itself being separated (or demixed) on the TLC plate. In FIG. 21A the unretained compound had an H_{obs} of −0.6 μm (1,865,000 N/m), the H_{obs} for the band with an R_{F} of 0.93 was 0.3 μm (520,000 N/m), and the band with an R_{F} of 0.80 had an efficiency of 8.8 μm (80,000 N/m). In FIG. 21B the unretained compound had an H_{obs} of −0.2 μm (830,000 N/m), the H_{obs} for the band with an R_{F} of 0.92 was 3.2 μm (164,000 N/m), and the band with an R_{F} of 0.85 had an efficiency of H_{obs} of 7.4 μm (87,000 N/m). Because σ²_{chrom} is adjusted with σ²_{SA}, the unretained chromatographic band has a zero or negative H_{obs} because the band is focused by the solvent front, i.e., the width of the band after development is smaller than the spot application width. It is not possible to compare the H_{obs} values herein with any from the previous work because no such unretained bands were observed.

Table 2 gives the results of the separations on the various TLC plates microfabricated. It is noteworthy that H_{obs} values in the range of 0.3 to 15.4 μm (58,000-520,000 N/m) are consistently obtained for the analytes. Such relatively high values are believed to be due to the simplification of the microfabrication scheme, i.e., with fewer fabrication steps on fewer pieces of equipment there is less heterogeneity introduced into the plates.

TABLE 2

| Type I | | Type I | | Type II | |
|---|---|---|---|---|---|
| | Plate Height | | Plate Height | | Plate Height |
| R_{F} | (μm) | R_{F} | (μm) | R_{F} | (μm) |
| 1.00 | −0.3 | 1.00 | −0.5 | 1.00 | −0.5 |
| 0.89 | 2.3 | 0.90 | 0.4 | 0.91 | 1.8 |
| 0.75 | 10.5 | 0.77 | 6.9 | 0.80 | 8.5 |
| Development Time | | Development Time | | Development Time | |
| 2 min 55 sec | | 3 min 01 sec | | 2 min 18 sec | |
| Type II | | Type II | | Type III | |
| | Plate Height | | Plate Height | | Plate Height |
| R_{F} | (μm) | R_{F} | (μm) | R_{F} | (μm) |
| 1.00 | −0.6 | 1.00 | −0.3 | 1.00 | −0.4 |
| 0.93 | 0.3 | 0.90 | 1.1 | 0.89 | 5.5 |
| 0.80 | 8.8 | 0.80 | 7.2 | 0.73 | 13.8 |

| | | |
|---|---|---|
| Development Time | Development Time | Development Time |
| 2 min 26 sec | 2 min 20 sec | 2 min 11 sec |

| | |
|---|---|
| Type IV | Type IV (FIG. 3b) |

| | Plate Height | | Plate Height |
|---|---|---|---|
| R_{F} | (μm) | R_{F} | (μm) |
| 1.00 | −0.2 | 1.00 | −0.2 |
| 0.93 | 2.1 | 0.92 | 3.2 |
| 0.85 | 6.8 | 0.85 | 7.4 |

| | |
|---|---|
| Development Time | Development Time |
| 2 min 45 sec | 2 min 45 sec |

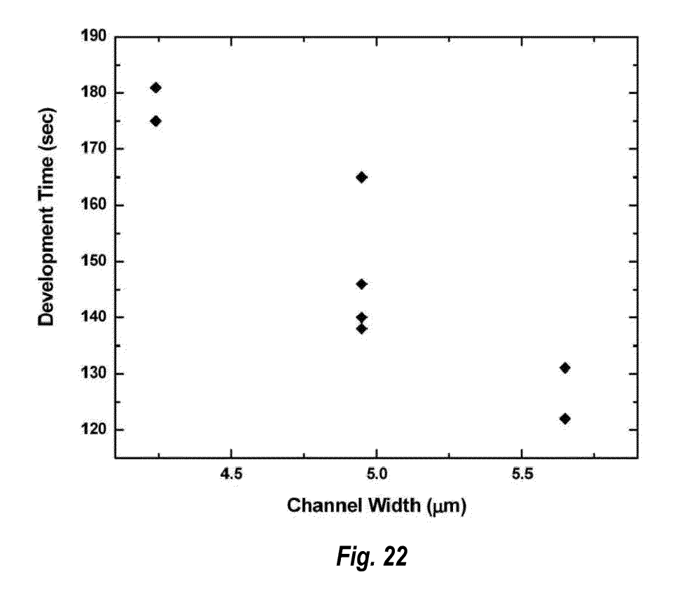

The data in Table 2 provide an interesting opportunity to compare the development times of TLC plates with different channel widths. According to theory, the mobile phase velocity should decrease (increased development time) as channel width decreases. FIG. 22 is a plot of all the development times for all the plates microfabricated vs. the channel widths of the different plates. While there is limited statistical data, it does strongly suggest that development times increase with decreasing channel width. From this limited data set the relationship appears linear. Additionally, the limited chromatographic efficiencies presented in Table 2 are consistent with the notion that larger chromatographic features give larger values of H_{obs}, i.e., poorer efficiencies.

As shown by the working examples, oxidation of CNT forests using ozone effectively primes them for subsequent deposition of SiO₂ by pseudo-ALD. Ozonation is a relatively simple process that can replace one or more relatively complicated priming steps. The resulting TLC plates perform very well chromatographically—e.g., tested plates show higher efficiencies than any the present inventor has prepared to date, with a maximum efficiency for an unretained compound of −0.6 μm (1,865,000 N/m). Furthermore, the presented channel width study demonstrates that the mobile phase velocity is higher on plates with wider channels. A limited study of channel and hedge width is consistent with wider hedges and channels resulting in less efficient separations.

The described embodiments may be used in different types of liquid or gas chromatography, such as high-performance liquid chromatography (“HPLC”), ultra-performance liquid chromatography (“UPLC”), microfluidic applications, pressurized liquid chromatography, microfluidic or nanofluidic chromatography, circular or anti-circular TLC, and any other type of chromatography application. Various columns or separations media for HPLC, UPLC, microfluidic applications containing the patterned or un-patterned infiltrated CNTs, a number of different assays (e.g., fingerprinting of natural products or screening for radical scavengers and antioxidants) are within the scope of the present disclosure.

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall be open ended and have the same meaning as the word “comprising” and variants thereof (e.g., “comprise” and “comprises”).

What is claimed is:

1. A method for manufacturing a chromatography apparatus, the method comprising:
forming a catalyst layer on a substrate;
forming a layer of elongated nanostructures on the catalyst layer; and
oxidizing the elongated nanostructures by contacting the elongated nanostructures with a gas to form a surface enriched in oxygen moieties for promoting subsequent deposition of a coating including at least one of a stationary phase or a precursor of a stationary phase for use in chromatography; and
at least partially coating the surface enriched in oxygen moieties with the coating including at least one of a stationary phase or a precursor of a stationary phase.

2. The method as recited in claim 1, wherein oxidizing the elongated nanostructures is performed at ambient temperature.

3. The method as recited in claim 1, wherein oxidizing the elongated nanostructures is performed by contacting the elongated nanostructures with ozone for about 15 minutes to about 1 hour.

4. The method as recited in claim 1, wherein oxidizing the elongated nanostructures is performed by contacting the elongated nanostructures with ozone until a surface concentration of oxygen on the elongated nanostructures is at least about 1 atomic percent.

5. The method as recited in claim 1, wherein oxidizing the elongated nanostructures is performed by contacting the elongated nanostructures with ozone until a surface concentration of oxygen on the elongated nanostructures is at least about 2 atomic percent.

6. The method as recited in claim 1, wherein the elongated nanostructures are not primed, the elongated nanostructures being ozone treated to form a surface enriched in oxygen moieties on the elongated nanostructures.

7. The method as recited in claim 1, wherein at least partially coating the surface enriched in oxygen moieties with the coating includes forming the coating to include at least one material selected from the group consisting of silicon, silicon dioxide, silicon nitride, aluminum, aluminum oxide, titanium, titanium oxide, zirconium, and zirconium oxide.

8. The method as recited in claim 7, wherein forming the coating to include at least one material selected from the group consisting of silicon, silicon dioxide, silicon nitride, aluminum, aluminum oxide, titanium, titanium oxide, zirconium, and zirconium oxide includes at least partially infiltrating the elongated nanostructures by atomic layer deposition or pseudo-atomic layer deposition with silicon dioxide.

9. The method as recited in claim 1, further comprising exposing the coating to at least one of an acid or base in order to bond hydroxyl groups to the stationary phase.

10. The method as recited in claim 9, further comprising exposing the stationary phase to a silane in order to bond silane groups to the stationary phase.

11. The method as recited in claim 10, wherein the silane includes an amino silane.

12. The method as recited in claim 11, wherein the amino silane includes 3-aminopropyltriethoxysilane.

13. The method as recited in claim 1, wherein forming a layer of elongated nanostructures on the catalyst layer includes growing a layer of carbon nanotubes on the catalyst layer.

14. The method as recited in claim 1, further comprising, after the act of at least partially coating the primed elongated nanostructures with the coating, at least partially removing the elongated nanostructures.

15. The method as recited in claim 14, wherein at least partially removing the elongated nanostructures includes oxidizing the elongated nanostructures so that they are substantially removed.

16. The method as recited in claim 1, wherein oxidizing the elongated nanostructures includes treating the elongated nanostructures with at least one of ozone, hydrogen peroxide, peroxide, CO₂, CO, or O₂.

17. The method as recited in claim 1, wherein each of the elongated nanostructures include at least one adhesion priming layer for promoting subsequent deposition of the coating thereon at least partially coating a carbon nanotube.

18. The method as recited in claim 17, wherein oxidizing the elongated nanostructures includes oxidizing, the carbon nanotubes, the at least one adhesion priming layer, or both.

19. A method for manufacturing a chromatography apparatus, the method comprising:
forming a catalyst layer on a substrate;
forming a layer of elongated nanostructures on the catalyst layer;
ozone treating the elongated nanostructures by contacting the elongated nanostructures with ozone to form a surface enriched in oxygen moieties for promoting subsequent deposition of a coating including at least one of a stationary phase or a precursor of a stationary phase for use in chromatography; and
at least partially coating the surface enriched in oxygen moieties with the coating including at least one of a stationary phase or a precursor of a stationary phase, deposition of the stationary phase or precursor of a stationary phase being directly onto the elongated nanostructures so that no priming layer is present between the elongated nanostructure and the stationary phase or stationary phase precursor.

20. The method as recited in claim 19, wherein ozone treating the elongated nanostructures is performed by contacting the elongated nanostructures with ozone until a surface concentration of oxygen on the elongated nanostructures is at least about 2 atomic percent.
